(19) United States
(12) Patent Application Publication
(10) Pub. No.: US 2026/0067408 A1
(43) Pub. Date: Mar. 5, 2026

(54) IMAGE PROCESSING APPARATUS, CONTROL METHOD, AND STORAGE MEDIUM

(71) Applicant: CANON KABUSHIKI KAISHA, Tokyo (JP)

(72) Inventor: SHUUHEI KAWAKAMI, Tokyo (JP)

(21) Appl. No.: 19/267,849

(22) Filed: Jul. 14, 2025

(30) Foreign Application Priority Data
Sep. 3, 2024 (JP) 2024-151330

(51) Int. Cl. H04N 1/00; H04N 1/44

(52) U.S. Cl. CPC H04N 1/00482; H04N 1/00244; H04N 1/00427; H04N 1/00506; H04N 1/4426; H04N 2201/0094

(57) ABSTRACT

An image processing apparatus includes: a reception unit configured to receive, from an external server, an instruction to execute a job and a setting value selected in the external server from a plurality of setting values that can be set in the image processing apparatus; a generation unit configured to generate a setting screen to accept setting of the job by a user based on the received setting value; and a display control unit configured to display the setting screen.

### BACKGROUND

### Field of the Technology

The present disclosure relates to a technique to accept a job from a Web server.

### Description of the Related Art

There is a multi function peripheral (MFP) as an image processing apparatus that includes hardware such as a scanner and a printer.

Japanese Patent Laid-Open No. 2012-80256 describes a system in which a Web server and an MFP including a Web browser are connected to each other via a network. In the system as described in Japanese Patent Laid-Open No. 2012-80256, the Web server can provide a screen on the Web browser of the MFP and accept various instructions from a user via the Web browser of the MFP.

### SUMMARY

An image processing apparatus of the present disclosure includes: a reception unit configured to receive, from an external server, an instruction to execute a job and a setting value selected in the external server from a plurality of setting values that can be set in the image processing apparatus; a generation unit configured to generate a setting screen to accept setting of the job by a user based on the received setting value; and a display control unit configured to display the setting screen.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of an image processing system;

FIG. 2 is a block diagram illustrating an example of a hardware configuration of an MFP;

FIG. 3 is a block diagram illustrating an example of a hardware configuration of a Web serve;

FIG. 4 is a block diagram illustrating an example of a functional configuration of an apparatus forming the image processing system;

FIGS. 5A to 5C are diagrams illustrating an example of a data configuration managed by the MFP;

FIGS. 6A to 6C are diagrams illustrating an example of a data configuration managed by the Web server;

FIG. 7A is a sequence diagram describing job execution processing;

FIG. 7B is a sequence diagram describing the job execution processing;

FIGS. 8A and 8B are diagrams illustrating an example of a screen displayed by the MFP on a display unit;

FIGS. 9A to 9C are diagrams illustrating an example of a screen provided by a Web application and displayed on a Web browser of the MFP;

FIGS. 10A and 10B are diagrams illustrating an example of a job setting screen displayed by the MFP on the display unit;

FIGS. 11A to 11C are diagrams illustrating an example of a screen displayed by the MFP on the display unit;

FIG. 12 is a diagram illustrating an example of a screen provided by the Web application and displayed on the Web browser of the MFP;

FIG. 13 is a diagram illustrating an example of a settable value list;

FIG. 14 is a flowchart describing settable value list generation processing;

FIGS. 15A to 15C are diagrams illustrating an example of a setting list;

FIG. 16 is a flowchart describing setting list generation processing;

FIG. 17 is a flowchart describing scan setting screen generation processing;

FIG. 18 is a flowchart describing the scan setting screen generation processing;

FIGS. 19A and 19B are diagrams illustrating an example of the job setting screen displayed by the MFP on the display unit;

FIG. 20 is a flowchart describing the scan setting screen generation processing;

FIG. 21 is a flowchart describing the scan setting screen generation processing; and

FIG. 22 is a flowchart describing the scan setting screen generation processing.

### DESCRIPTION OF THE EMBODIMENTS

In some cases, a system as described in Japanese Patent Laid-Open No. 2012-80256 performs an operation in which a Web server, which accepts an instruction of a user via a Web browser of an MFP, requests the MFP to execute a job based on the instruction of the user, and the MFP executes the job according to the request.

In this case, you may want to have a Web application included in the Web server control the settings of the jobs that the MFP executes. However, in a case of having the Web application control the setting of the job that the MFP executes, there is a problem that the cost of development of the Web application may increase.

According to a technique of the present disclosure, it is possible to control the setting of the job instructed to the image processing apparatus by the Web application while suppressing the cost of development of the Web application.

Embodiments of the technique of the present disclosure are described below with reference to the drawings.

### Embodiment 1

In the present embodiment, a method in which an MFP as an image processing apparatus displays a job setting screen based on an instruction of a Web server is described.

### [System Configuration]

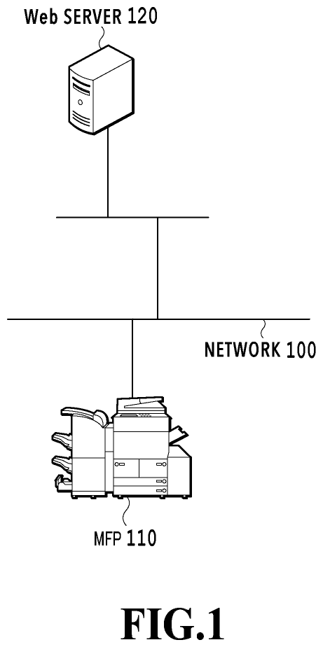

FIG. 1 is a diagram illustrating an example of a system configuration of an image processing system that is an information processing system in the present embodiment. The image processing system includes a multi function peripheral (hereinafter, referred to as MFP) 110 and a Web server 120. The MFP 110 and the Web server 120 are communicably connected to each other via a network 100. Note that, the Web server 120 may be on the Internet, or the MFP 110 may be in a local area network. Additionally, in the image processing system of the present embodiment, the numbers of the MFP 110 and the Web server 120 are not limited.

The MFP 110 is an apparatus of an example of the image processing apparatus in the present embodiment. The MFP 110 is an image processing apparatus having a scan function, a print function, and the like, and a detailed configuration is described later.

As an example, the Web server 120 is described as a file server that saves a file transmitted from the MFP 110. In addition, the Web server 120 may be a file server that prints a file transmitted from the MFP 110 or an application server that executes various types of processing such as image conversion in response to a request from the MFP 110.

### [About Service Provided by Web Server and MFP in Cooperation]

The Web server 120 of the present embodiment executes a Web application program (Web application) that can be utilized from a Web browser of the MFP 110. The Web server 120 has a function of providing various services to a user in cooperation with the MFP 110 by executing the Web application.

There is a Web application of an insurance company as an example of the Web application executed by the Web server 120. For example, the Web application of the insurance company provides a service that allows for submission of a document required for various applying like an insurance for automobile accidents from the MFP 110. Specifically, the user accesses and logs in the Web server 120 on which the Web application is installed from the Web browser of the MFP 110. The Web application on the Web server 120 displays a screen that instructs the user to scan the required document on the Web browser of the MFP 110. Once the user sets the required document on a scanner of the MFP 110, and the MFP 110 scans the document, a scanned image obtained as a result of the scanning is transmitted to the Web server 120. The Web server 120 saves a scanned image file transmitted from the MFP 110. With the utilization of the Web application of the insurance company as described above, the user can submit the required document to the insurance company in the form of data from the MFP 110.

Considering a business logic for the service provided by the Web application as described above, some of job settings such as scan setting and print setting are expected to be selected by the user, and some of them are not expected to be selected by the user. For example, in a case of the above-described service to submit the scanned image of the document via the MFP 110, since the scanned image is an evidence image, it is necessary to save the scanned image that expresses the actual document more accurately in the Web server 120. For this reason, in some cases, as the scan setting that can be selected by the user, it is required in color mode setting to set only color to be selectable so as not to allow scanning in grayscale. In addition, for example, since a high-resolution image is required in a case where image processing such as character recognition is performed from the scanned image, there may also be a thought that it is required to prevent scanning with the scan setting at a resolution of 100×100.

However, in principle, the job setting screen controlled by the MFP 110 itself is a screen on which all the setting values supported by the MFP 110 are selectable. Therefore, there may be a method of generating the job setting screen by the Web application on the Web server 120 and displaying the job setting screen generated by the Web application on the Web browser of the MFP 110. For example, if the Web application on the Web server 120 generates a scan setting screen that does not allow the user to select grayscale as the color mode setting, the user cannot select grayscale as the scan setting.

Then, the Web application on the Web server 120 may receive the job setting inputted by the user from the job setting screen displayed on the Web browser and may instruct the MFP 110 to execute the job with the received setting. In this case, the MFP 110 executes the job in response to the job execution instruction from the Web server 120 and displays a job-in-execution screen.

However, in a case of generating the job setting screen itself on a side of the Web application on the Web server 120, the cost of development of the Web application is increased. For example, man-hours are required to develop the job setting screen of the Web application. Additionally, in some cases, the Web application is operated by a different company from a development company of the MFP 110, and it is necessary to confirm a specification of the MFP 110 with the development company of the MFP 110.

Under the circumstances, in the present embodiment, a method that allows the MFP 110 to display the job setting screen taking into account a demand from the Web application side while suppressing the cost on the Web application side is described.

### [Hardware Configuration of MFP]

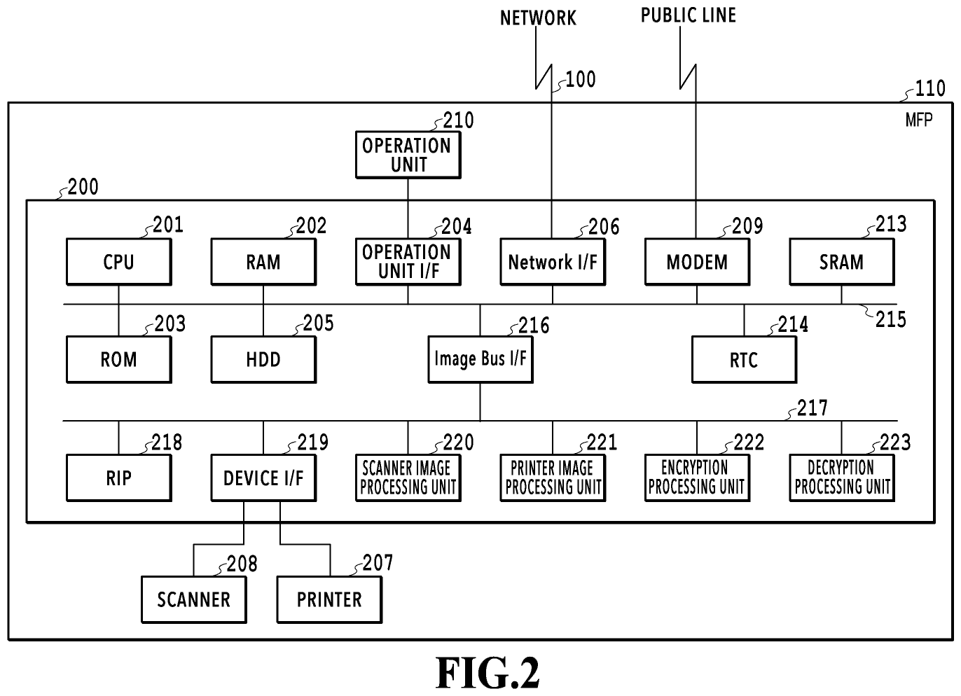

FIG. 2 is a block diagram illustrating an overview of a hardware configuration of the MFP 110 in the present embodiment. The MFP 110 includes an operation unit 210, a control unit 200, a scanner 208 that is an image input device to read an original document, and a printer 207 that is a device to output an image by printing.

The operation unit 210 has functions of a display unit that displays various menus, the Web browser, the setting screen, and so on and an input unit that accepts an input by the user. The operation unit 210 includes a display unit having a touch panel function, a physical button, and the like, for example.

The control unit 200 is connected with the scanner 208 and the printer 207 and connected with the network 100 or a public line to input and output image information and device information. The control unit 200 includes a CPU 201, a RAM 202, a ROM 203, an operation unit I/F 204, an HDD 205, a network I/F 206, a MODEM 209, an SRAM 213, and an RTC 214 arranged on a system bus 215. Additionally, an Image Bus I/F 216 is included.

The CPU 201 is a processor that controls overall the MFP 110. The RAM 202 is a system working memory for the CPU 201 to operate and is also an image memory to temporarily store image data. The RAM 202 functions as a main memory, a working area, and the like of the CPU 201. The RAM 202 stores setting information of the MFP 110, a job log in a case of performing each processing, an operation log, and so on. The ROM 203 is a boot ROM that stores a boot program of the system. The HDD 205 is a hard disk drive that stores system software, an application, and the image data. The HDD 205 stores a program to execute a sequence and a flowchart described later. The SRAM 213 is a non-volatile storage medium that can operate at high speed.

The operation unit I/F 204 is an interface that controls displaying on the display unit included in the operation unit 210, a key input and a hardware key input from the operation unit 210, and the like and outputs data of the screen to be displayed on the display unit of the operation unit 210 to the operation unit 210. The operation unit I/F 204 transmits the information inputted by the user of the information processing system in FIG. 1 from the operation unit 210 to the CPU 201. The CPU 201 operates as a display control unit that controls displaying of the screen on the display unit of the operation unit 210 and an operation control unit that controls the input unit of the operation unit 210.

The RTC 214 is a real-time clock that performs processing of counting continuously the current time even in a state in which the control unit 200 is not powered.

The network I/F 206 performs a network interface output. The MODEM 209 is connected to the public line and inputs and outputs information. The MFP 110 can communicate with the Web server 120 via the network I/F 206 based on the instruction of the CPU 201. Thus, the MFP 110 can establish communication by an HTTP protocol. For example, the MFP 110 can log in the Web server 120, transmit the instruction from the user to the Web application, receive the print data, and transmit the scan data. The CPU 201 operates as a transmission control unit that transmits the information to the Web server 120 and a reception control unit that receives the information from the Web server.

The Image Bus I/F 216 is a bus bridge that connects the system bus 215 to an image bus 217 transferring the image data at high speed and converts a data structure. The image bus 217 is formed of a PCI bus or IEEE 1394.

The control unit 200 further includes an RIP unit 218, a device I/F 219, a scanner image processing unit 220, a printer image processing unit 221, an encryption processing unit 222, and a decryption processing unit 223 arranged on the image bus 217.

The RIP unit 218 is a raster image processor that rasterizes PDL data to a bitmap image. The device I/F 219 connects the scanner 208 and the printer 207 to the control unit 200 and converts the image data synchronously and asynchronously. The scanner image processing unit 220 performs correcting, processing, and editing of the inputted image data. The printer image processing unit 221 performs correcting, resolution conversion, and the like of the printer for the printed and outputted image data. The encryption processing unit 222 performs encryption processing of input data including the image data. The decryption processing unit 223 performs decryption processing of the encrypted data.

### [Hardware Configuration of Web Server]

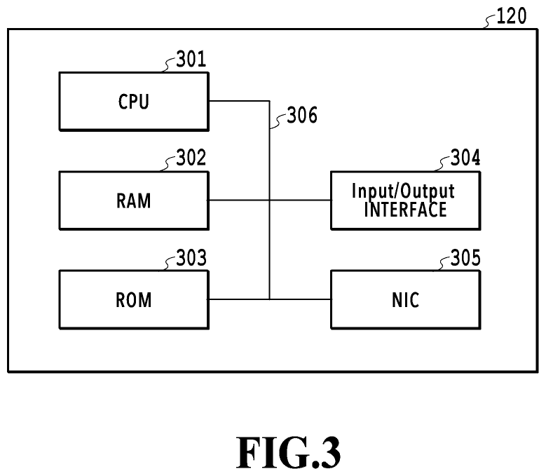

FIG. 3 is a diagram illustrating an example of a hardware configuration of the Web server 120. The Web server 120 includes a CPU 301, a RAM 302, a ROM 303, an Input/Output interface 304, an NIC 305, and a bus 306.

The CPU 301 deploys a program such as an OS or a general application stored in the ROM 303 for programs to the RAM 302 to execute and controls overall the devices connected to the bus 306. The ROM 303 stores an operating system program as a control program of the CPU 301 and various types of data. The RAM 302 is a storage unit that functions as a main memory, a working area, and the like of the CPU 301.

The Input/Output interface 304 displays the screen on the display unit connected with the Web server 120 and controls a key input and the like from the operation unit connected with the Web server 120. The NIC 305 is connected to the network 100 and executes processing of controlling communication with another device such as the MFP 110 that is similarly connected to the network 100.

### [Functional Configuration of MFP]

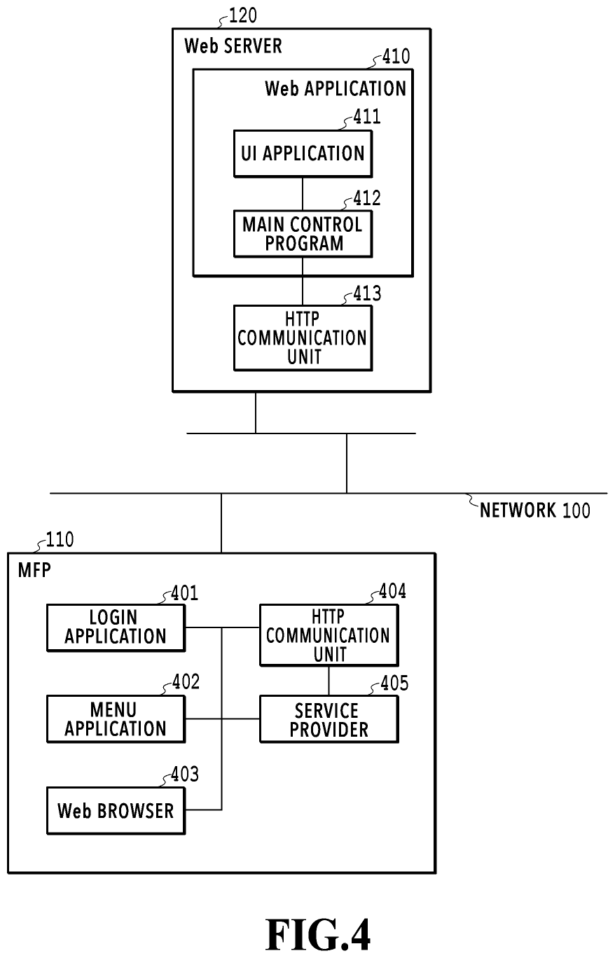

FIG. 4 is a diagram describing a functional configuration of the image processing system of the present embodiment.

The MFP 110 includes a login application 401, a menu application 402, a Web browser 403, an HTTP communication unit 404, and a service provider 405.

The login application 401 is a software module that allows for an input of login information and performs authentication to identify the user utilizing the MFP 110 and generates login user information. The login application 401 holds a list of user information who can utilize the MFP 110 and available functions. A login method of the user may be a method that allows the user to input a user ID and a password by a software keyboard displayed on the display unit of the operation unit 210 or may be a method utilizing an IC card. In the present embodiment, it is described assuming that the user information is held inside the MFP 110; however, a configuration to transmit inputted authentication information to an external user information management server to authenticate the information by the user information management server and receive the login information may be applied.

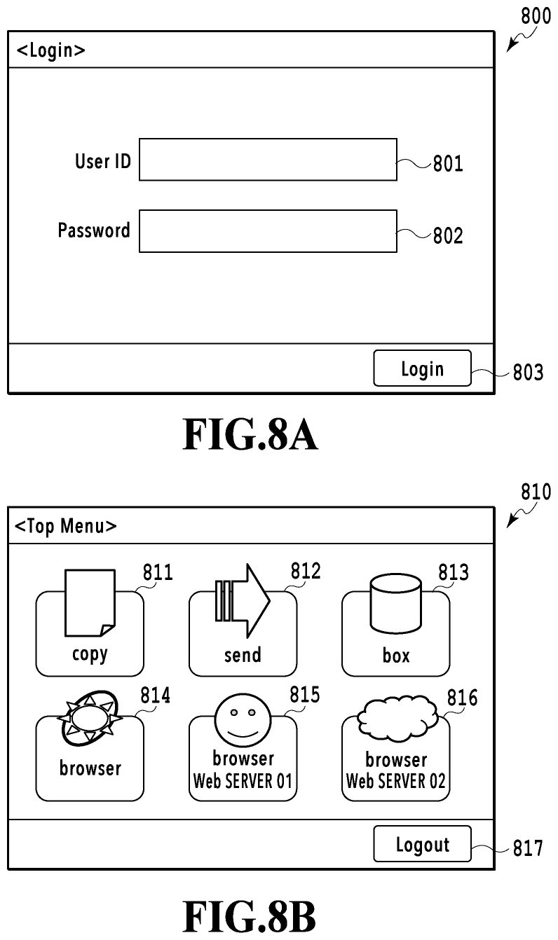

The menu application 402 is a software module having a function of displaying a screen to activate each software module included in the MFP 110. The menu application 402 displays a device menu screen 810 (see FIG. 8B) that displays a graphical user interface (GUI) button in the form of a list, which is to display a copy screen, a screen of the Web browser described later, and the like. In addition, the menu application 402 allows the user to select the GUI button.

The Web browser 403 is a Web browser that establishes communication with the device on the network via the later-described HTTP communication unit 404. The Web browser 403 requests the Web application according to a designated URL to provide HTML data. Additionally, the Web browser 403 functions also as a display control unit that renders the HTML data included in a response received via the HTTP communication unit 404 and displays the HTML data on the display unit of the operation unit 210. Moreover, the Web browser 403 transmits the user input provided to the operation screen displayed on the display unit of the operation unit 210 as a request.

The HTTP communication unit 404 is a software module that operates the network I/F 206 and establishes communication by the HTTP protocol.

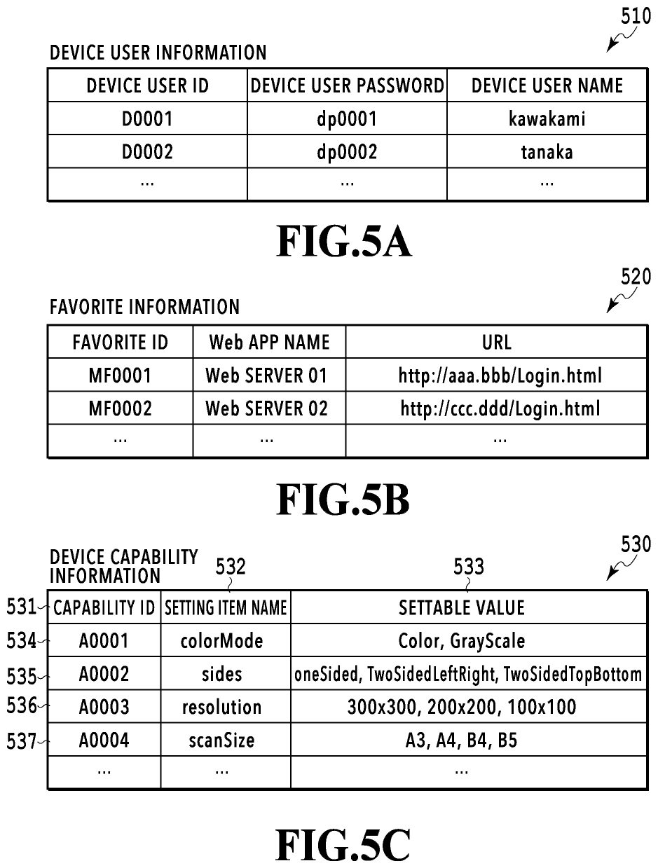

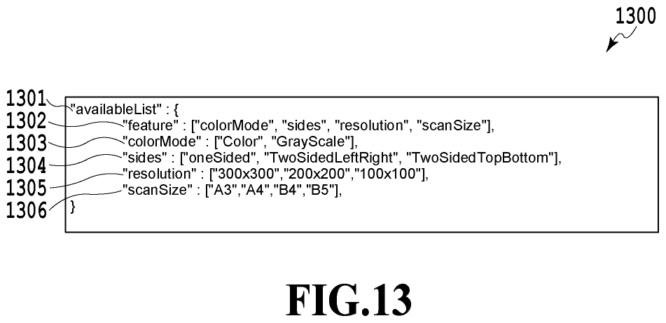

The service provider 405 causes the MFP 110 to perform job execution such as scan processing, print processing, and transmission processing according to the request received via the HTTP communication unit 404. The service provider 405 has a function of generating a settable value list 1300 (see FIG. 13) from a device capability information table 530 (see FIG. 5C) of the MFP 110. Additionally, the service provider 405 functions also as a transmission unit that transmits the generated settable value list 1300 to the Web server 120 via the HTTP communication unit 404.

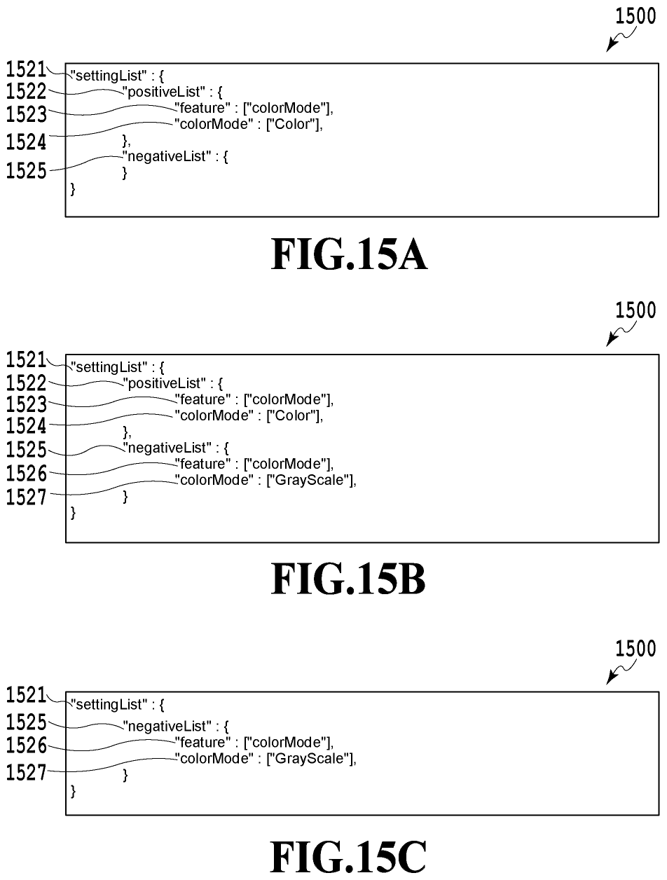

The service provider 405 functions also as a reception unit that receives a setting list 1500 (see FIGS. 15A to 15C) from the Web server 120 by way of the HTTP communication unit 404. Additionally, the service provider 405 functions also as a generation unit that generates the job setting screen based on the setting list 1500 based on the instruction from the Web server 120. Details are described later.

The service provider 405 functions also as a display control unit that displays the job setting screen, the job-in-execution screen, a preview screen, an execution result screen, and so on based on the instruction from the Web server 120 on the display unit of the operation unit 210. The service provider 405 obtains the file and the like as a result of the job after the MFP 110 executes the job and transmits the obtained file and the like to the Web server 120 by way of the HTTP communication unit 404.

Each functional module of the MFP 110 illustrated in each block in FIG. 4 is implemented with the CPU 201 executing a predetermined program stored in the HDD 205; however, it is not limited thereto. In addition, for example, hardware may be utilized, the functional module may be implemented by cooperation between software and hardware such as a dedicated IC, or a part of or all the functions may be implemented by only hardware.

### [Functional Configuration of Web Server]

The Web server 120 includes an HTTP communication unit 413 and a UI application 411 and a main control program 412 as a Web application 410. The Web application 410 is a collective term of the UI application 411 and the main control program 412 operating on the Web server 120. The Web application 410 operates integrally with the MFP 110 such that the UI application 411 performs processing for UI processing, and the main control program 412 performs processing for another type of business logic processing and the like, respectively.

In response to the HTTP request from the Web browser 403 via the HTTP communication unit 413, the UI application 411 transmits the screen that should be displayed as a result to the Web browser 403 of the MFP 110 as a response. The UI application 411 receives form data inputted via the screen displayed on the Web browser 403 via the HTTP communication unit 413.

The main control program 412 controls the Web server 120. In response to the input from the user and another device, the UI application 411 and the HTTP communication unit 413 requests the main control program 412 to perform the processing. The UI application 411 performs the processing in response to the request from the Web browser 403 of the MFP 110 via the network 100 and returns the HTML data to be displayed on the Web browser 403 of the MFP 110.

The main control program 412 performs the processing on the form data provided from the UI application 411. For example, the main control program 412 performs the authentication according to the information inputted to a form on an authentication screen by the user and instructs about the screen that should be displayed.

The main control program 412 receives the settable value list 1300 (see FIG. 13) from the MFP 110 by way of the HTTP communication unit 413. The settable value list 1300 is data holding the multiple setting values settable in the MFP 110 for each setting item name.

The main control program 412 selects the setting value of the MFP 110 that is expected to be selected by the user as the job setting from the settable value list 1300 and generates a positive list including the selected setting value. Additionally, the main control program 412 selects the setting value of the MFP 110 that is not expected to be selected by the user as the job setting from the settable value list 1300 and generates a negative list including the selected setting value. Then, the main control program 412 generates the setting list 1500 (see FIGS. 15A to 15C) including the positive list and the negative list. Details are described later.

The main control program 412 transmits the generated setting list 1500 to the MFP 110 by way of the HTTP communication unit 413, and the main control program 412 transmits the job execution instruction to the MFP 110. The job execution instruction includes an instruction to the MFP 110 to display the job setting screen based on the generated setting list 1500.

The main control program 412 receives the file and the like as a result of the job execution from the MFP 110 by way of the HTTP communication unit 413 and instructs the UI application 411 to display a screen to notify the user of the result of the job execution according to the result.

The HTTP communication unit 413 is a software module that operates the NIC 305 and establishes communication by the HTTP protocol.

Each functional module of the Web server 120 illustrated in each block in FIG. 4 is implemented with the CPU 301 executing a predetermined program loaded in the RAM 302; however, it is not limited thereto. In addition, for example, hardware may be utilized, the functional module may be implemented by cooperation between software and hardware such as a dedicated IC, or a part of or all the functions may be implemented by only hardware.

### [About Information Managed by MFP]

FIGS. 5A to 5C are diagrams describing information used by the MFP 110. Each table illustrated in FIGS. 5A to 5C is saved in the RAM 202 and the ROM 203 of the MFP 110, an external memory, or the like and is processed by each module included in the MFP 110 illustrated in FIG. 4.

FIG. 5A is a diagram illustrating an example of a device user information table, which is an example of a data structure to manage information about a device user who is the user of the MFP 110. A device user information table 510 holds the information of the device user for each device user ID uniquely identifying the device user. For example, as the information of the device user, a device user password, which is a password to authenticate the device user, and a device user name, which is a name of the device user, are held in association with the device user ID.

FIG. 5B is a diagram illustrating an example of a favorite information table, which is an example of a data structure to manage the above-described Web application 410. A favorite information table 520 holds a Web app name indicating a name of the Web application and a URL indicating a URL for the access to the Web application for each favorite ID uniquely identifying favorite information of the MFP 110. The URL held in the favorite information table 520 is a Uniform Resource Locator, which indicates a position of the Web application 410 on the Web server 120 on the network 100.

FIG. 5C is a diagram illustrating an example of a device capability information table, which is an example of a data structure to manage device capability information that is information of the setting value supported by the MFP 110 (called a settable value). In FIG. 5C, as an example, the settable value in a case where the MFP 110 performs scanning by using the scanner 208 is held.

In the device capability information table 530, an identifier (a capability ID) is applied to the device capability information for each item name. In addition, the settable value indicating the capability supported by the MFP 110 (also called a capability value) is managed for each capability ID.

The device capability information with the capability ID of “A0001” holds the setting item name of “colorMode” and the settable values in the MFP 110 of “Color” and “GrayScale.” This indicates that the MFP 110 has a capability of scanning in color, which is indicated by “Color,” and in grayscale, which is indicated by “GrayScale,” as a color mode. In other words, it is indicated that the MFP 110 can accept either color or grayscale indicated by the settable value as the scan setting for the setting of the color mode indicated by the setting item name.

The device capability information with the capability ID “A0002” holds “sides” indicating imposition setting in a case of scanning as the setting item name. Additionally, “oneSided” indicating one-sided, “TwoSidedLeftRight” indicating two-sided left-and-right binding, and “TwoSidedTopBottom” indicating two-sided top-and-bottom binding are held as the settable value in the MFP 110. Therefore, it is indicated that the MFP 110 has a capability of accepting the one-sided, the two-sided left-and-right binding, and the two-sided top-and-bottom binding as the scan setting for the imposition setting in a case of scanning.

The device capability information of the capability ID “A0003” holds “resolution” indicating setting of the resolution of the scanning as the setting item name. Additionally, “300×300” indicating 300 dpi×300 dpi, “200×200” indicating 200 dpi×200 dpi, and “100×100” indicating 100 dpi×100 dpi are held as the settable value in the MFP 110. Therefore, it is indicated that the MFP 110 has a capability of accepting the setting values that are 300 dpi×300 dpi, 200 dpi×200 dpi, and 100 dpi×100 dpi as the scan setting for the setting of the resolution in a case of scanning.

The device capability information with the capability ID “A0004” holds “scanSize” indicating setting of a scan size as the setting item name. Additionally, “A3” indicating A3 size, “A4” indicating A4 size, “B4” indicating B4 size, and “B5” indicating B5 size are held as the settable value in the MFP 110. Therefore, it is indicated that the MFP 110 has a capability of accepting A3, A4, B4, and B5 as the scan setting for the size setting in a case of scanning.

### [About Information Managed by Web Server]

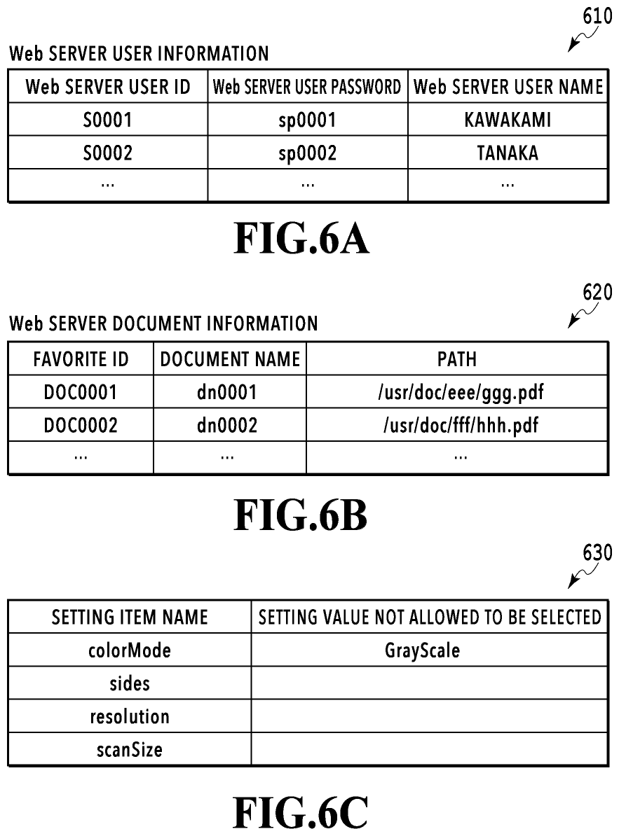

FIGS. 6A to 6C are configuration diagrams of information used by the Web server 120 according to the present embodiment. Each piece of information in FIGS. 6A to 6C is saved in the RAM 302 and the ROM 303 of the Web server 120 illustrated in FIG. 3, an external memory, or the like and is processed by the functional module of the Web server 120 illustrated in FIG. 4.

FIG. 6A is a diagram illustrating an example of a Web server user information table 610, which is an example of a data structure to manage information related to the Web server user who is the user of the Web server 120. The Web server user information table 610 holds the information of the Web server user for each Web server user ID uniquely identifying the Web server user. For example, a Web server user password, which is a password to authenticate the Web server user, and a Web server user name, which is a name of the Web server user, are held as the information of the Web server user in association with the Web server user ID.

FIG. 6B is a diagram illustrating an example of a Web server document information table, which is an example of a data structure to manage an entire scanned image (scanned document) saved in the Web server 120. A Web server document information table 620 holds information of a server document for each document ID uniquely identifying the scanned image of the document stored in the Web server 120. For example, a document name, which indicates a name of the document indicated by the scanned image, and a path, which indicates a saving place of the scanned image such as the RAM, the ROM, and the external memory, are stored as the information of the server document in association with the document ID. The path is written under “/usr” because the application such as the Web application 410 is installed under “/usr” in general. Details of FIG. 6C are described later.

FIGS. 5A to 5C are examples of the information saved in the MFP 110, and FIGS. 6A to 6C are examples of the information held in the Web application 410. Therefore, although the data structure of FIGS. 5A to 5C and FIGS. 6A to 6C is illustrated in a table format that is a database format, the format is not limited to the table format.

### [Sequence Diagram]

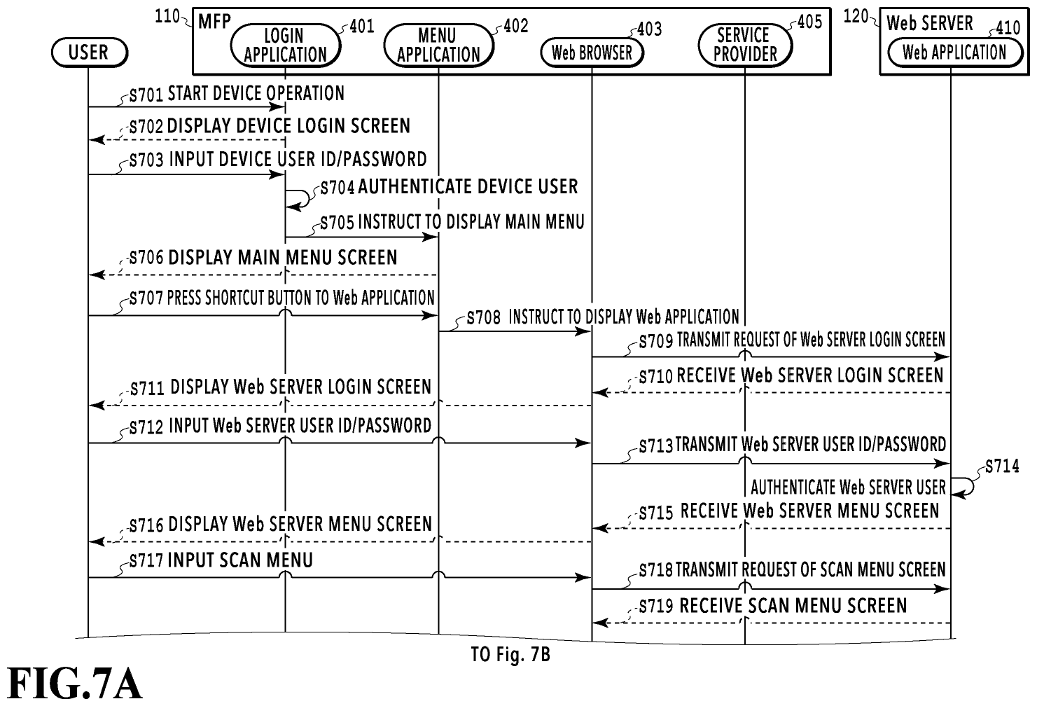

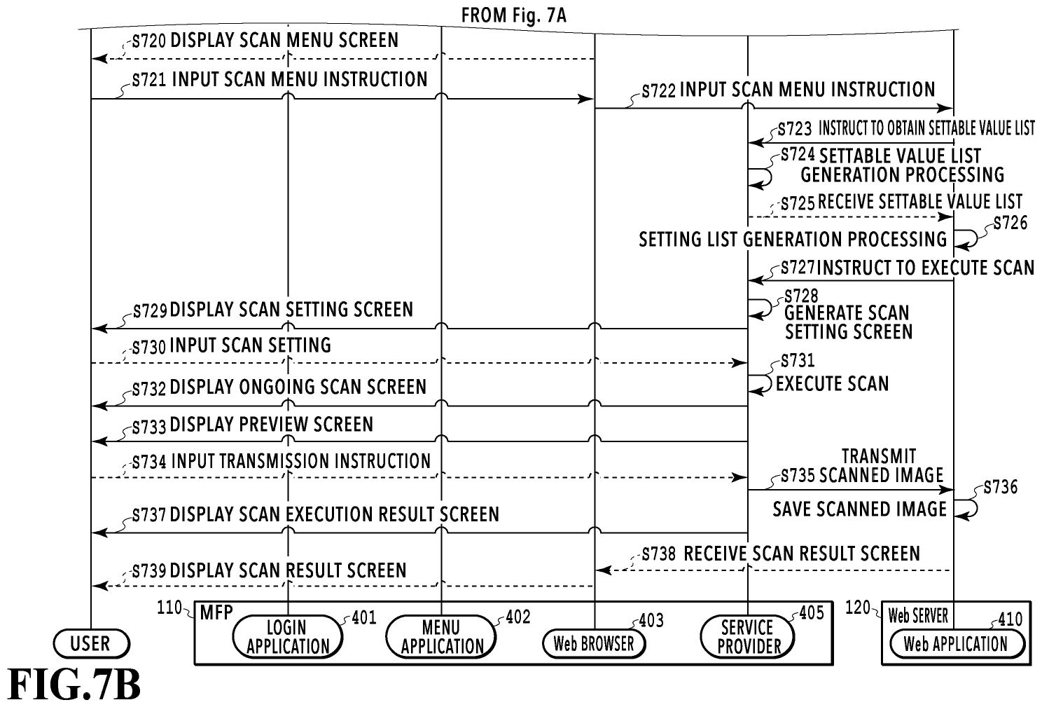

FIGS. 7A and 7B are sequence diagrams illustrating the exchange between the MFP 110 and the Web server 120. In some cases, FIGS. 7A and 7B are collectively described as FIG. 7. With reference to FIG. 7, a series of processing procedure in which the user starts operating the MFP 110, the Web server 120 performs the authentication processing and provides the scan instruction, and the MFP 110 executes the scan processing and transmits the execution result to the Web server 120 is described.

In the processing performed according to the sequence diagram in FIG. 7, the processing performed by the MFP 110 is performed with the CPU 201 deploying the program code stored in the HDD 205, the ROM 203, or the like to the RAM 202 to execute. The processing performed by the Web application 410 is performed with the CPU 301 deploying the program code stored in the ROM 303 and the like to the RAM 302 to execute. Alternatively, a part of or all the steps in the sequence diagram of FIG. 7 may be implemented by hardware such as an ASIC and an electronic circuit. A sign “S” in the description of each processing in the following sequence diagram or flowchart means it is the step, and the same applies to the subsequent flowcharts.

In S701, the user starts the operation by using the display unit or the hardware key included in the operation unit 210 of the MFP 110 to utilize the service provided by the Web application 410 of the Web server 120. In a power saving state, the MFP 110 detects a button input with the user pressing any button on the operation unit 210.

In S702, the login application 401 of the MFP 110 displays a device login screen 800 (see FIG. 8A) on the display unit of the operation unit 210 in the MFP 110. In a case other than the power saving state, it is a state in which the device login screen 800 is already displayed.

FIG. 8A is a diagram illustrating an example of the device login screen 800. The device login screen 800 is a login screen that is displayed by the login application 401 in a case where the user performs device login on the MFP 110. The device login screen 800 includes an area 801 to which the device user ID is inputted and an area 802 to which the device password is inputted. In addition, the device login screen 800 includes a login button 803 to start the device authentication processing according to the inputted content.

In S703, the user inputs the device user ID and the device password on the device login screen 800 and presses the login button 803. The login application 401 of the MFP 110 detects that the user presses the login button 803 on the device login screen 800.

In S704, the login application 401 of the MFP 110 performs the device user authentication processing. The login application 401 determines whether the device user ID and the device password inputted by the user match the device user ID and the device password held in the device user information table 510. If the device user IDs and the device passwords match, respectively, the login application 401 determines that the device login succeeds.

In S705, if it is determined in S704 that the device login succeeds, the login application 401 requests the menu application 402 to display the device menu screen 810 (see FIG. 8B).

In S706, the menu application 402 displays the device menu screen 810 (see FIG. 8B), which is a screen displayed on the operation unit 210 of the MFP 110 after the login to the MFP 110.

FIG. 8B is a diagram illustrating an example of the device menu screen 810. The device menu screen 810 includes a GUI button 811 to activate a copy application, a GUI button 812 to activate a transmission application, and a GUI button 813 to activate a document saving application. The device menu screen 810 includes GUI buttons 814, 815, and 816 to activate the Web browser 403 and obtain a specific URL. Additionally, a logout button 817 to allow the user to log out the device is included.

In the present embodiment, each of the GUI buttons 815 and 816 is set to connect to the Web server as a connection destination based on the favorite information held in the favorite information table 520 illustrated in FIG. 5B. For example, the GUI button 815 is set to connect to “http://aaa.bbb/Login.html” that is the URL of the Web server 120 with the favorite ID “MF0001” to perform obtainment and displaying on the Web browser. Additionally, it is assumed that the GUI button 816 is set to connect to “http://ccc.ddd/Login.html” that is the URL of a not-illustrated Web server with the favorite ID “MF0002” to perform obtainment and displaying on the Web browser.

Hereinafter, it is described that the user accesses the Web server 120 with the favorite ID “MF0001” and the Web application 410 is utilized. As an example, it is assumed that the Web application 410 of the present embodiment is an application that provides a service that allows the user to submit the required document in the form of data via the MFP 110. Therefore, it is described in the following descriptions that the job is a scan transmission job and the job setting screen is a scan setting screen.

In S707, the user presses the GUI button 815 to access the Web application 410 out of menu buttons on the device menu screen 810.

In S708, in a case where the pressing of the GUI button 815 is detected, the menu application 402 designates the URL of the Web server 120 set to the GUI button 815 and instructs the Web browser 403 to perform displaying based on the URL.

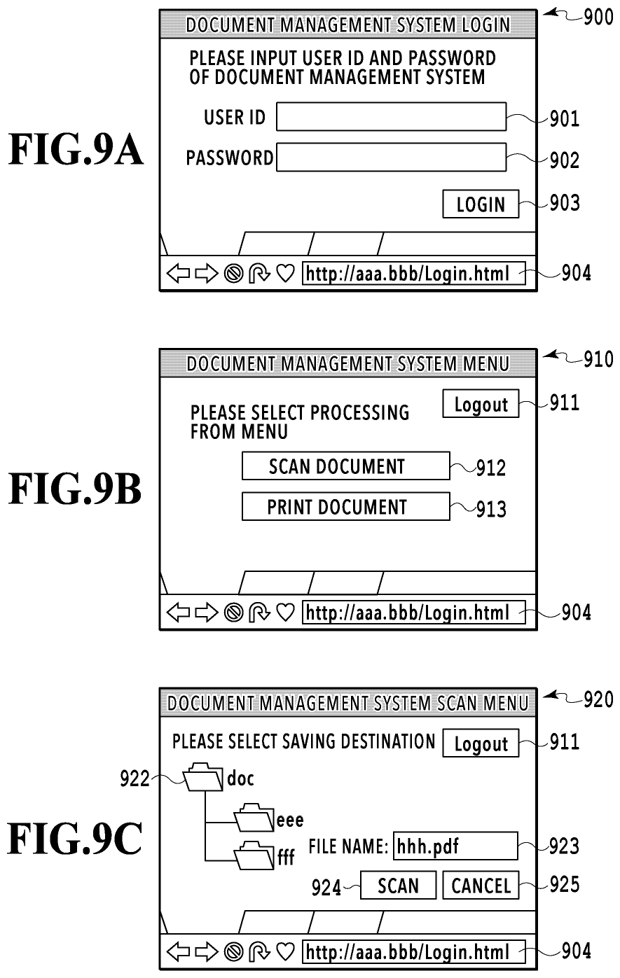

In S709, the Web browser 403 accesses the URL of the Web server 120 and transmits the request to the Web server 120 to provide the information to display a Web server login screen 900 (see FIG. 9A).

In S710, the UI application 411 that is the Web application 410 of the Web server 120 transmits the information of the Web server login screen 900 to the MFP 110. The Web browser 403 of the MFP 110 receives the information of the Web server login screen 900 from the Web server 120.

In S711, the MFP 110 displays the Web server login screen 900 on the Web browser 403 displayed on the display unit included in the operation unit 210. The Web server login screen 900 is a screen to log in the Web application 410 from the Web browser 403.

FIGS. 9A to 9C are diagrams illustrating examples of the Web server screen on the Web server 120, which is displayed on the Web browser 403 of the MFP 110. FIG. 9A is a diagram illustrating an example of the Web server login screen 900. The Web server login screen 900 includes a Web server user ID input area 901 and a Web server password input area 902. The Web server login screen 900 includes a login button 903 to start the authentication processing according to the inputted content and a URL display area 904 to display the URL of the Web server 120.

In S712, once the user inputs the Web server user ID and the password from the Web server login screen 900 and presses the login button 903, the Web browser 403 detects the pressing of the login button 903.

In S713, the Web browser 403 accesses the Web server 120 and transmits the Web server user ID and the password inputted by the user in S712 to the Web server 120.

In S714, the main control program 412 that is the Web application 410 of the Web server 120 performs Web server user authentication processing. The main control program 412 determines whether the Web server user ID and the password transmitted from the Web browser 403 match the Web server user ID and the Web server password held in the Web server user information table 610. If the Web server user IDs and the Web server passwords match, respectively, the main control program 412 determines that the login succeeds.

In S715, if it is determined that the login succeeds, the UI application 411 of the Web server 120 transmits the information of a Web server menu screen 910 (see FIG. 9B) to the MFP 110. The Web browser 403 receives the information of the Web server menu screen 910 from the Web server 120.

In S716, the MFP 110 displays the Web server menu screen 910 on the Web browser 403 displayed on the display unit included in the operation unit 210. The Web server menu screen 910 is a screen to allow the user to select the processing of the Web application 410 on the Web browser 403.

FIG. 9B is a diagram illustrating an example of the Web server menu screen 910. The Web server menu screen 910 includes a logout button 911, a document scan button 912, a document print button 913, and the above-described URL display area 904. The logout button 911 is a button to log out from the Web application 410. The document scan button 912 is a button to start the document scan processing of the Web server 120. The document print button 913 is a button to start the document print processing of the Web server 120.

In S717, it is assumed that the user presses the document scan button 912 of the Web server menu screen 910. In this case, the Web browser 403 detects the document scan button 912.

In S718, the Web browser 403 accesses the Web server 120 and transmits a notification about the pressing of the document scan button 912 by the user in S717 to the Web server 120.

In S719, the UI application 411 of the Web server 120 transmits information of a scan menu screen 920 (see FIG. 9C) to the MFP 110. Specifically, the UI application 411 reads out the Web server document information held in the Web server document information table 620 in FIG. 6B and generates a folder tree 922 based on the information of the path. The Web browser 403 receives the information of the scan menu screen 920 from the Web server 120.

In S720, the MFP 110 displays the scan menu screen 920 on the Web browser 403 displayed on the display unit included in the operation unit 210.

FIG. 9C is a diagram illustrating an example of the scan menu screen 920. The scan menu screen 920 includes a folder tree 922, a document name input box 923, a scan button 924, a cancel button 925, the above-described logout button 911, and the above-described URL display area 904. The folder tree 922 is a folder tree to indicate the folder configuration on the Web server 120 and select a folder to save the scanned image.

The scan button 924 is a button to instruct the MFP 110 to start the document scan processing. The cancel button 925 is a button to instruct the MFP 110 to perform cancel processing. The document name input box 923 is an input box to input a name of the scanned image generated by the MFP 110 in a case where the scan button 924 is pressed.

In S721, it is assumed that the user selects the folder from the scan menu screen 920, inputs the file name, and presses the scan button 924. In this case, the Web browser 403 detects the pressing of the scan button 924. That is, the Web browser 403 detects the instruction by the user to execute the job.

In S722, the Web browser 403 accesses the Web server 120 and transmits the folder and the file name inputted by the user in S721 to the Web server 120.

In S723, the main control program 412 of the Web server 120 transmits the instruction to obtain the settable value list 1300 (see FIG. 13) to the MFP 110. The service provider 405 of the MFP 110 receives the instruction to obtain the settable value list 1300.

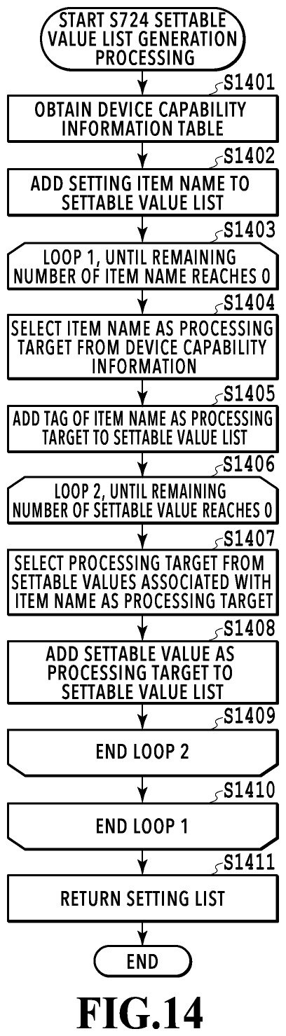

In S724, the service provider 405 executes settable value list generation processing. Det ails of the settable value list generation processing are described later with reference to FIG. 14.

In S725, the service provider 405 transmits the settable value list 1300 generated in S724 to the Web server 120. The main control program 412 of the Web server 120 receives the settable value list 1300.

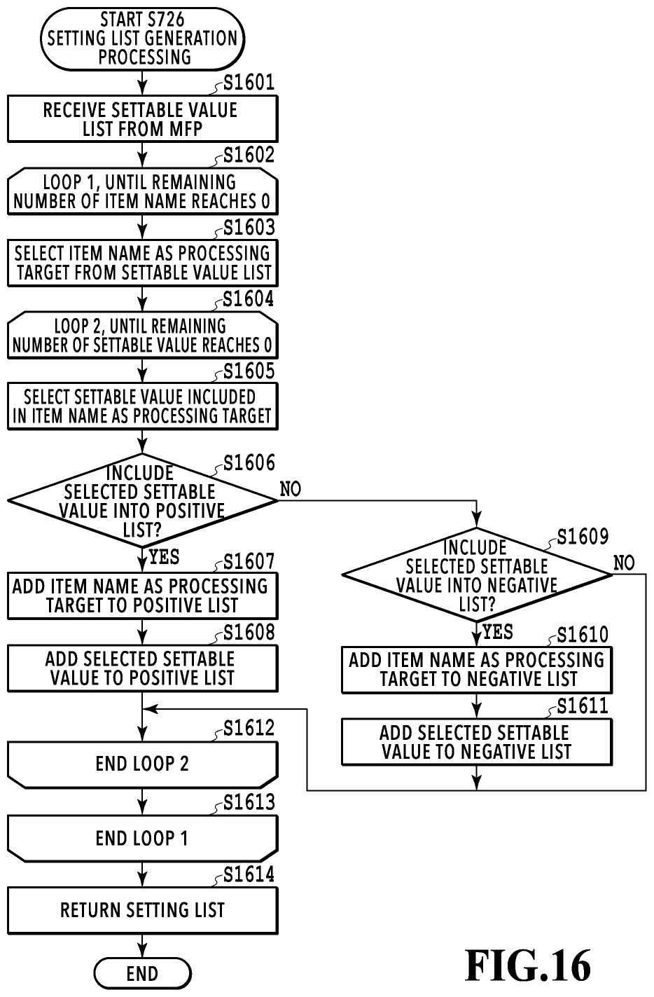

In S726, the main control program 412 of the Web server 120 executes setting list generation processing. Details of the setting list generation processing are described later with reference to FIG. 16.

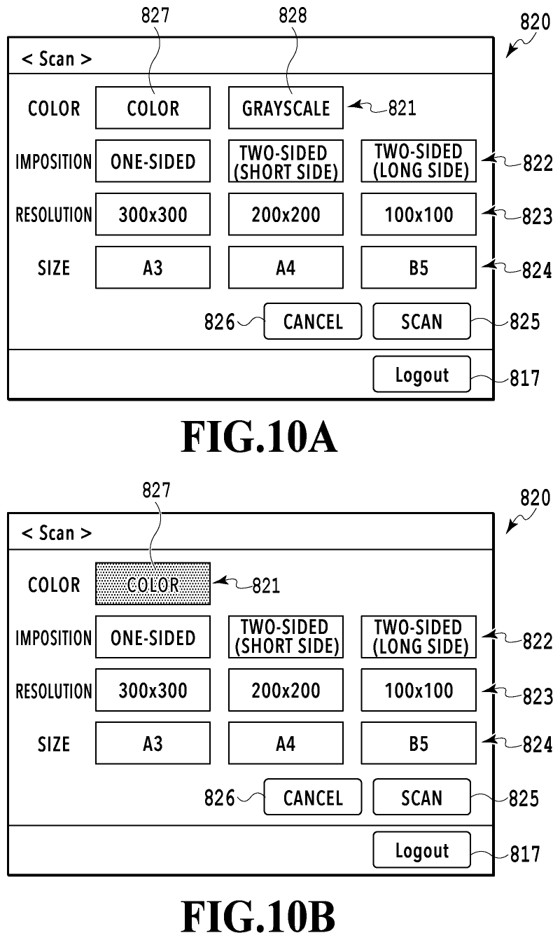

In S727, the main control program 412 transmits the setting list 1500 (see FIGS. 15A to 15C) generated in S726 to the MFP 110 and transmits the job execution instruction to the MFP 110. The job execution instruction includes an instruction to the MFP 110 to display a scan setting screen 820 (see FIGS. 10A and 10B) based on the generated setting list 1500. The service provider 405 of the MFP 110 receives the job execution instruction and the setting list 1500.

In S728, the service provider 405 of the MFP 110 executes job setting screen generation processing. That is, the MFP 110 executes processing of generating the scan setting screen 820 that is the job setting screen of the present embodiment.

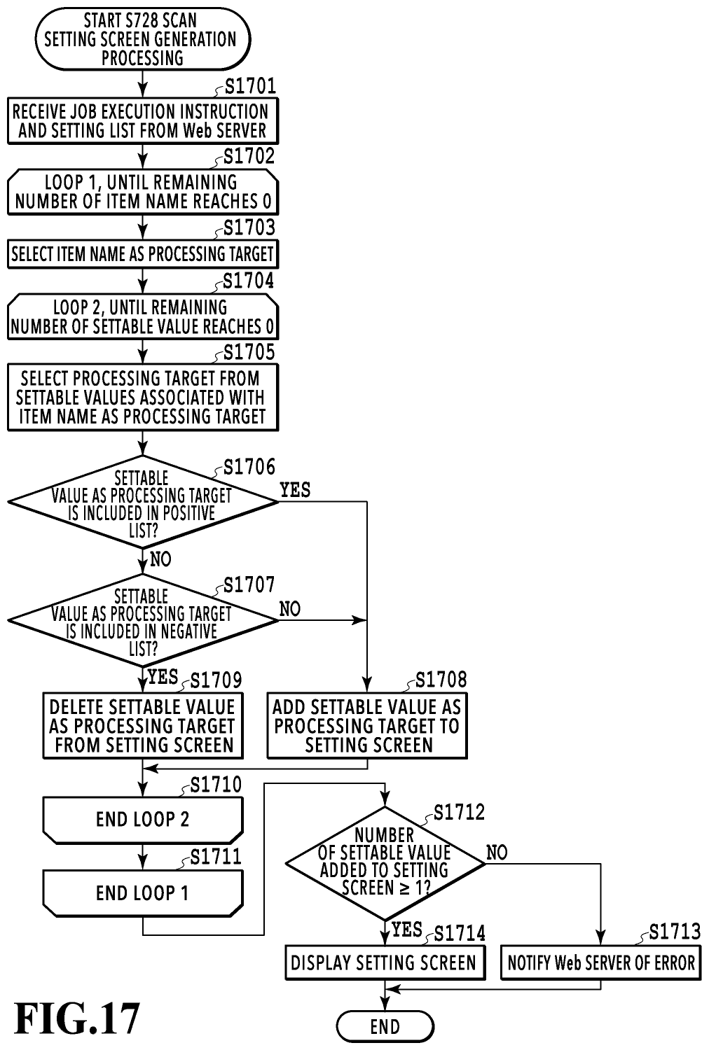

In the present embodiment, the service provider 405 of the MFP 110 generates the job setting screen based on the setting list 1500 generated by the Web application 410; details are described later with reference to FIG. 17. Therefore, the job setting screen, which allows the user to select the setting value that the Web application 410 expects to be set, can be generated by the MFP 110, not by the Web application 410.

In S729, the service provider 405 of the MFP 110 displays the scan setting screen 820 (see FIGS. 10A and 10B) generated in S728 on the display unit included in the operation unit 210 of the MFP 110. That is, the screen on the display unit included in the operation unit 210 is switched from the Web browser to the scan setting screen 820.

FIGS. 10A and 10B are diagrams illustrating examples of the scan setting screen 820 that is the job setting screen of the present embodiment. In S729, the scan setting screen 820 as illustrated in FIG. 10A or the scan setting screen 820 as illustrated in FIG. 10B is displayed. The scan setting screen 820 is described with reference to FIG. 10A.

The scan setting screen 820 includes a color selection button display region 821, an imposition selection button display region 822, a scan resolution selection button display region 823, and a scan size selection button display region 824. In addition, a scan button 825 for the scan instruction, a cancel button 826, and the above-described logout button 817 are included.

The color selection button display region 821 is a region to display a GUI button to select whether to read the original document in color or in grayscale in a case where the scanner 208 scans the original document.

The imposition selection button display region 822 is a region to display a GUI button to select imposition of the document as a scan target. The scan resolution selection button display region 823 is a region to display a GUI button to select the resolution in a case of scanning. The scan size selection button display region 824 is a region to display a GUI button to select the size of the document as the scan target.

In S730, the user performs scan setting by pressing the GUI button corresponding to a desired settable value from the scan setting screen 820 and thereafter presses the scan button 825. The service provider 405 detects the pressing of the scan button 825.

In S731, the service provider 405 of the MFP 110 executes the scan transmission job according to the scan setting inputted by the user in S730. Specifically, the service provider 405 transmits the scan setting to the scanner 208 by way of the device I/F 219 and instructs the scanner 208 to perform scanning. Then, the service provider 405 obtains the scanned image obtained as a result of the scanning by the scanner 208.

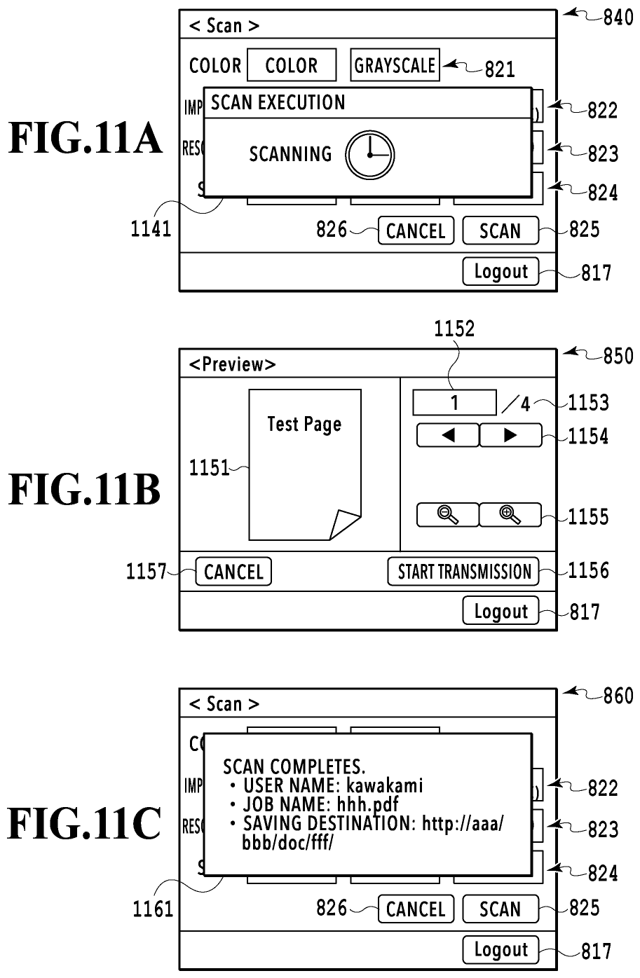

In S732, the service provider 405 displays an ongoing scan screen 840 (see FIG. 11A) on the display unit included in the operation unit 210 of the MFP 110. S731 and S732 are executed in parallel and non-synchronously. During the scan processing in S731, the ongoing scan screen 840 is displayed in S732.

FIG. 11A is a diagram illustrating an example of the ongoing scan screen 840. The ongoing scan screen 840 is a screen of a state in which an ongoing scan dialogue 1141 is overlapped and displayed on the scan setting screen 820. Therefore, block diagrams having the same number as that of the scan setting screen 820 are the same as the block diagrams of the scan setting screen 820, respectively.

In S733, the service provider 405 displays a preview screen 850 (see FIG. 11B) to show a preview to the user on the display unit included in the operation unit 210.

FIG. 11B is a diagram illustrating an example of the preview screen 850. The preview screen 850 displays a preview image 1151, a page display box 1152, total page number display 1153, a page feeding button 1154, and a page scaling button 1155. In addition, the preview screen 850 includes a transmission start button 1156, a cancel button 1157, and the above-described logout button 817.

In S734, it is assumed that the user presses the transmission start button 1156 on the preview screen 850. In this case, the service provider 405 detects the pressing of the transmission start button 1156.

In S735, the service provider 405 transmits the scanned image obtained as a result of S731 to the Web server 120. The main control program 412 of the Web server 120 receives the scanned image. Thus, the scan transmission job by the MFP 110 is completed.

In S736, the main control program 412 of the Web server 120 saves the scanned image received in S735 in the RAM 302, the ROM 303, the external memory, or the like. The main control program 412 registers the document information such as the document name and the path indicating the saving place with the Web server document information table 620 in FIG. 6B.

In S737, the service provider 405 displays a scan execution result screen 860 (see FIG. 11C) on the display unit included in the operation unit 210 of the MFP 110. S736 and S737 are executed in parallel and non-synchronously. In S737, the scan execution result screen 860 is displayed for a certain period of time.

FIG. 11C is a diagram illustrating an example of the scan execution result screen 860. The scan execution result screen 860 is a screen on which a scan execution result dialogue 1161 is displayed on the scan setting screen 820. Therefore, block diagrams having the same number as that of the scan setting screen 820 are the same as the block diagrams of the scan setting screen 820, respectively. The scan execution result dialogue 1161 displays the user name, the job name, and a saving destination URL.

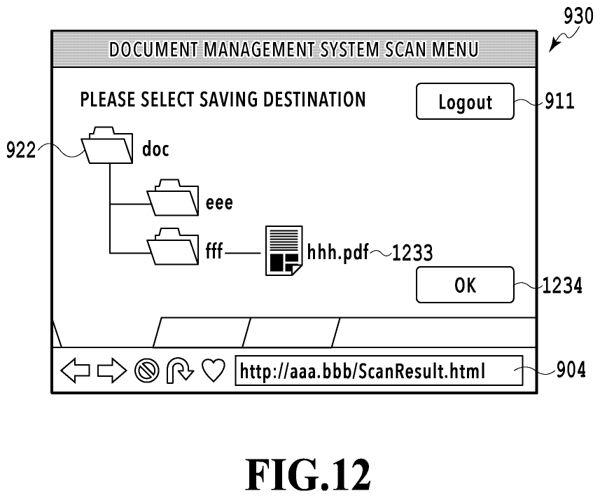

In S738, the UI application 411 of the Web server 120 transmits information of a scan result screen 930 (see FIG. 12) to the MFP 110. Then, the Web browser 403 of the MFP 110 receives the information of the scan result screen 930 from the Web server 120. The scan result screen 930 is a screen to display the scan processing result generated by the Web server 120 on the Web browser 403.

In S739, the MFP 110 switches the display on the display unit included in the operation unit 210 to the display of the Web browser, and the Web browser 403 displays the scan result screen 930. Then, the processing ends.

FIG. 12 is a diagram illustrating an example of the scan result screen 930, which is one of the Web server screens on the Web server 120 displayed on the Web browser 403 of the MFP 110. The scan result screen 930 includes a document name display region 1233, an OK button 1234, the above-described folder tree 922, logout button 911, and URL display area 904. The document name display region 1233 displays the name of the scanned image obtained by the job this time. The OK button 1234 is a button to indicate that the user completes confirmation of the result.

### [About Settable Value List]

FIG. 13 is a diagram illustrating an example of the settable value list 1300 generated by the MFP 110 in S724. In the present embodiment, it is described that the settable value list 1300 is generated as a file in a JavaScript Object Notation (JSON) format. The settable value list 1300 is not limited to the JSON format and may be a file in another format such as an XML format and a CSV format, for example.

The settable value list 1300 is data obtained by converting the setting item name and the settable value in the device capability information table 530 in FIG. 5C into the JSON format. In the present embodiment, it is described that the settable value list 1300 is information holding the settable value supported by the MFP 110 as the scan setting. Note that, the settable value list 1300 may be information holding the settable value supported by the MFP 110 for setting other than the scan setting.

An example of a specific described content in the settable value list 1300 is described with reference to FIG. 13. An availableList tag 1301 indicates that the following description is the settable value list. A feature tag 1302 indicates the setting item name included in the settable value list 1300.

Since the settable value list 1300 of the present embodiment is the settable value list of the scan setting, the feature tag 1302 is associated with the setting item name of the scan setting. In addition, “colorMode” indicates the color mode, “sides” indicates imposition, “resolution” indicates the scan resolution, and “scanSize” indicates the scan size. The setting item name associated with the feature tag 1302 is an example, and another setting item name may be associated.

A colorMode tag 1303 is associated with the settable value of the MFP 110 in the color mode setting. “Color” associated with the colorMode tag 1303 is color, and “GrayScale” associated with the colorMode tag 1303 is grayscale. That is, it is indicated that the MFP 110 can accept either setting, color or grayscale, as the color mode setting. The settable value associated with the colorMode tag 1303 is an example, and another value may be associated.

A sides tag 1304 is associated with the settable value of imposition. “OneSided” indicates one-sided, “TwoSidedLeftRight” indicates two-sided left-and-right binding, and “TwoSidedTopBottom” indicates two-sided top-and-bottom binding. The settable value associated with the sides tag 1304 is an example, and another value may be associated.

A resolution tag 1305 is associated with the settable value of the scan resolution. “300×300” indicates 300 dpi×300 dpi, “200×200” indicates 200 dpi×200 dpi, and “100×100” indicates 100 dpi×100 dpi. The settable value associated with the resolution tag 1305 is an example, and another value may be associated.

A scanSize tag 1306 is associated with the settable value of the scan size. “A3” indicates A3 size, “A4” indicates A4 size, “B4” indicates B4 size, and “B5” indicates B5 size. The settable value associated with the scanSize tag 1306 is an example, and another value may be associated.

### [Settable Value List Generation Processing]

FIG. 14 is a flowchart describing details of the settable value list generation processing executed by the service provider 405 on the MFP 110 in S724. The processing performed according to the flowchart in FIG. 14 is executed with the CPU 201 of the MFP 110 reading out the program code stored in the HDD 205 and the like to the RAM 202 to execute. Alternatively, a part of or all the steps in the sequence diagram in FIG. 14 may be implemented by hardware such as an ASIC and an electronic circuit.

In S1401, the service provider 405 of the MFP 110 obtains the device capability information table 530 in FIG. 5C saved in the storage unit such as the RAM 202 and the ROM 203 of the MFP 110 or the external memory.

In S1402, the service provider 405 adds the setting item name held in a column 532 in the device capability information table 530 obtained in S1401 to the feature tag 1302 holding the setting item name of the settable value list 1300.

In a case where the device capability information table 530 in FIG. 5C is obtained, “colorMode,” “sides,” “resolution,” and “scanSize” held as the setting item name in the column 532 are added to the feature tag 1302.

Subsequent S1403 to S1410 are loop processing (a loop 1). In S1404, the service provider 405 selects the setting item name as a processing target from the setting item names held in the device capability information table 530 obtained in S1401. Then, the service provider 405 executes processing from S1405 to S1409 for the setting item name as the processing target, transitions to S1410, and returns to S1403. In S1403, if it is determined that there is the setting item name that is not selected as the processing target yet, the service provider 405 proceeds to S1404 again. In subsequent S1404, the item name as a new processing target is selected from the setting item names that are not selected yet, and the processing from S1405 to S1410 is repeated. In S1403, if it is determined that all the setting item names are selected as the processing target, the service provider 405 ends the processing of loop 1 and proceeds to S1411.

In S1405, the service provider 405 adds the tag of the setting item name as the processing target to the settable value list 1300. For example, if the setting item name as the processing target is “colorMode” held in the column 532 in FIG. 5C, the colorMode tag 1303 is added as illustrated in FIG. 13.

Subsequent S1406 to S1409 are loop processing (a loop 2). In S1407, the service provider 405 selects the settable value as the processing target from the settable values associated with the setting item name as the processing target of the loop 1 from the device capability information table 530 obtained in S1401. Then, the service provider 405 executes the processing in S1408 for the settable value as the processing target, transitions to S1409, and returns to S1406. In S1406, if it is determined that there is the settable value that is not selected as the processing target yet, the service provider 405 proceeds to S1407 again. In subsequent S1407, the settable value as a new processing target is selected from the settable values that are not selected yet, and the processing in S1408 is repeated. In S1406, if it is determined that all the settable values are selected as the processing target, the service provider 405 ends the processing of the loop 2 and proceeds to S1410.

In S1408, the service provider 405 adds the settable value as the processing target obtained in S1407 to the tag of the setting item name as the processing target of the loop 1 in the settable value list 1300.

For example, in a case where the setting item name as the processing target of the loop 1 is “colorMode,” the settable value as the processing target is selected from “color” and “GrayScale” associated with “colorMode” in FIG. 5C. For example, in a case where “Color” is selected as the settable value as the processing target, in S1408, the service provider 405 adds “Color” that is the settable value as the processing target to the colorMode tag 1303 in FIG. 13.

In S1411, the service provider 405 returns the settable value list 1300 generated as a result of performing S1401 to S1410. Then, the processing in the flowchart in FIG. 14 ends. As described above, the generated settable value list 1300 is transmitted to the Web server 120.

In some cases such as a case where the MFP 110 manages internal data in the JSON format, the information in FIG. 5C may be saved in advance in the MFP 110 in the JSON format. In this case, since the information saved in the MFP 110 is similar to that in FIG. 13, it is unnecessary to execute the processing in FIG. 14.

### [About Setting List]

FIGS. 15A to 15C are diagrams illustrating examples of the setting list generated by the Web server 120 in S726. In the present embodiment, the setting list 1500 is expressed as the file in the JSON format; however, it is not limited to the JSON format and may be a file in another format such as the XML format and the CSV format. As described above, the setting list 1500 includes at least one of the positive list and the negative list.

An example of a specific described content of the setting list 1500 is described with reference to FIG. 15B. A settingList tag 1521 indicates that the following description is the setting list.

A positiveList tag 1522 indicates that the following description is the positive list. A feature tag 1523 associated with the positiveList tag 1522 is associated with the setting item name included in the positive list. “ColorMode” indicates the color mode setting. A colorMode tag 1524 associated with the positiveList tag 1522 is associated with the setting value of the color mode included in the positive list. “Color” indicates color as the setting value. That is, it is indicated that the positive list in FIG. 15B includes “Color” that is the settable value of the MFP 110.

A negativeList tag 1525 indicates that the following description is the negative list. A feature tag 1526 associated with the negativeList tag 1525 is associated with the setting item name included in the negative list. “ColorMode” indicates the color mode setting. A colorMode tag 1527 associated with the negativeList tag 1525 is associated with the setting value of the color mode included in the negative list. “GrayScale” indicates grayscale as the setting value. That is, it is indicated that the negative list in FIG. 15B includes “GrayScale” as the settable value of the MFP 110.

The negativeList tag 1525 indicating the negative list of the setting list 1500 in FIG. 15A is not associated with the feature tag 1526 and the colorMode tag 1527. FIG. 15A is a diagram illustrating an example of the setting list in which the negative list includes no setting value.

The setting list 1500 in FIG. 15C does not include the positiveList tag 1522 indicating the positive list. FIG. 15C is a diagram illustrating an example of the setting list in which no positive list is included and only the negative list includes the setting value.

### [About Setting List Generation Processing]

FIG. 16 is a flowchart describing details of the setting list generation processing executed by the main control program 412 of the Web server 120 in S726. The processing performed according to the flowchart in FIG. 16 is executed with the CPU 301 of the Web server 120 reading out the program code stored in the ROM 303, the external memory, or the like to the RAM 302 to execute. Alternatively, a part of or all the steps in the sequence diagram in FIG. 16 may be implemented by hardware such as an ASIC and an electronic circuit.

In S1601, the main control program 412 obtains the settable value list 1300 transmitted from the MFP 110 in S725 in FIG. 7.

S1602 to S1613 are loop processing (a loop 1). In S1603, the main control program 412 selects the setting item name as the processing target from the setting item names associated with the feature tag 1302 of the settable value list 1300 obtained in S1601. Then, the main control program 412 executes the processing from S1604 to S1612 for the setting item name as the processing target, transitions to S1613, and returns to S1602. In S1602, if it is determined that there is the setting item name that is not selected as the processing target yet from the setting item names included in the feature tag 1302, the main control program 412 proceeds to S1603 again. In subsequent S1603, the setting item name as a new processing target is selected from the setting item names that are not selected yet, and the processing from S1604 to S1612 is repeated. In S1602, if it is determined that all the setting item names are selected as the processing target, the main control program 412 ends the processing of the loop 1 and proceeds to S1614.

S1604 to S1612 are loop processing (a loop 2). In S1605, the main control program 412 selects the settable value as the processing target from the settable values associated with the tag of the setting item name as the processing target of the loop 1 in the settable value list 1300. Then, the main control program 412 executes the processing from S1606 to S1611 for the settable value as the processing target, transitions to S1612, and returns to S1604. In S1604, if it is determined that there is the settable value that is not selected as the processing target yet in the settable values in the setting item name as the processing target of the loop 1, the main control program 412 proceeds to S1605 again. In subsequent S1605, the settable value as a new processing target is selected from the settable values that are not selected yet, and the processing from S1606 to S1611 is repeated. In S1604, if it is determined that all the settable values are selected as the processing target, the main control program 412 ends the processing of the loop 2 and proceeds to S1613.

In S1606, the main control program 412 determines whether to include the settable value as the processing target obtained in S1605 into the positive list. If it is determined to include the settable value as the processing target into the positive list (YES in S1606), the main control program 412 allows the processing to proceed to S1607, and if not (NO in S1606), the main control program 412 allows the processing to proceed to S1609.

In S1607, the main control program 412 associates the tag of the setting item name as the current processing target of the loop 1 with the positive list in the setting list 1500. For example, in a case where the processing target of the loop 1 is “colorMode,” the feature tag 1523 in the positiveList tag 1522 representing the positive list is associated with “colorMode,” and the colorMode tag 1524 is further added.

In S1608, the main control program 412 adds the settable value as the processing target obtained in S1605 to the positive list in the setting list 1500. Specifically, the main control program 412 associates the tag of the setting item name as the processing target in the positive list in the setting list 1500 with the settable value as the processing target. For example, in a case where the settable value as the processing target is “Color,” “Color” is added to the colorMode tag 1524 corresponding to the setting item name as the processing target of the loop 1 associated with the positiveList tag 1522 representing the positive list.

On the other hand, in S1609, the main control program 412 determines whether to include the settable value as the processing target obtained in S1605 into the negative list. If it is determined to include the settable value as the processing target into the negative list (YES in S1609), the main control program 412 allows the processing to proceed to S1610, and if not (NO in S1609), the main control program 412 allows the processing to proceed to S1612.

In S1610, the main control program 412 associates the tag of the item name of the current processing target of the loop 1 with the negative list in the setting list 1500. For example, in a case of “colorMode” as the processing target of the loop 1, “colorMode” is associated with the feature tag 1526 added to the negativeList tag 1525 representing the negative list, and the colorMode tag 1527 is further added.

In S1611, the main control program 412 adds the settable value as the processing target obtained in S1605 to the negative list in the setting list 1500. Specifically, the main control program 412 associates the settable value as the processing target of the loop 2 with the tag of the setting item name as the processing target of the loop 1 in the negative list in the setting list 1500. For example, it is assumed that the settable value as the processing target of the loop 2 is “GrayScale.” In this case, “GrayScale” is added to the colorMode tag 1527 that is the tag corresponding to the item name as the processing target of the loop 1 associated with the negativeList tag 1525 representing the negative list.

The setting list 1500 generated in the present flowchart is information to allow the Web application 410 to instruct the MFP 110 to generate the scan setting screen 820. For example, in a case of the Web application 410 that provides the user with the service to submit the scanned image of the document via the MFP 110, since the scanned image is an evidence image, it is necessary to save the scanned image that expresses the actual document more accurately. For this reason, for example, the Web application 410 generates the setting list 1500 that instructs the MFP 110 to perform scanning not in grayscale. The MFP 110 displays the scan setting screen 820 that does not allow the user to select the grayscale based on the setting list 1500; details are described later. Therefore, as a result, the Web application 410 can receive the scanned image in color that is obtained by scanning the required document in color.

An operator of the service provided by the Web application 410 only needs to determine in advance the setting value that is to be displayed or the setting value that is not to be displayed on the scan setting screen 820 depending on the service provided by the Web application 410. FIG. 6C is an example of a table 630 that manages the setting value that is determined by the operator not to be displayed on the scan setting screen 820. It is assumed that the table 630 is saved in a place from which the Web server 120 can obtain the table 630.

The main control program 412 included in the Web application 410 makes the determination in S1606 and S1609 based on the table 630 as illustrated in FIG. 6C. The table 630 in FIG. 6C is an example of the table that manages the value that is to be included in the negative list for each setting item name. Therefore, in a case where the Web server 120 holds the table 630 in FIG. 6C, the determination in S1606 on whether to include the settable value into the positive list is always NO. On the other hand, in a case where the settable value as the processing target of the loop 2 is “GrayScale,” the determination in S1609 on whether to include the settable value into the negative list is YES, and in a case of another settable value, the determination in S1609 is NO.

In a case where a table that manages the setting value that is to be included into the positive list for each setting item name is also generated in addition to the table 630 in FIG. 6C, the determination in S1606 on whether to include the settable value into the positive list may be made based on the table.

In S1614, the main control program 412 returns the setting list 1500 generated as a result of S1601 to S1613. Then, the processing in the flowchart in FIG. 16 ends. As described above, the generated setting list 1500 is transmitted to the MFP 110.

Note that, in a case where it is known that the configuration of the MFP 110 is not to be changed, the setting list 1500 generated in advance may be saved in the Web server 120. In this case, in S726 in FIG. 7, processing of obtaining the saved setting list 1500 is performed instead of the processing of generating the setting list.

### [Job Setting Screen Generation Processing Based on Setting List]

FIG. 17 is a flowchart describing the job setting screen generation processing executed by the service provider 405 on the MFP 110 in S728 in FIG. 7. The processing performed according to the flowchart in FIG. 17 is performed with the CPU 201 of the MFP 110 reading out the program code stored in the HDD 205 and the like to the RAM 202 to execute. Alternatively, a part of or all the steps in the sequence diagram in FIG. 17 may be implemented by hardware such as an ASIC and an electronic circuit.

In S1701, the service provider 405 of the MFP 110 receives the job execution instruction to the MFP 110 and the setting list 1500 that are transmitted by the Web application 410 of the Web server 120 in S727 in FIG. 7.

In subsequent S1702 to S1711, the service provider 405 of the MFP 110 performs the processing of generating the scan setting screen 820 that is the job setting screen of the present embodiment based on the setting list 1500 received from the Web application 410.

S1702 to S1711 are loop processing (a loop 1). In S1703, the main control program 412 selects the setting item name as the processing target from the setting item name held in the device capability information table 530. The service provider 405 executes the processing from S1704 to S1710 for the setting item name as the processing target, transitions to S1711, and returns to S1702. In S1702, if it is determined that there is the setting item name that is not selected as the processing target yet, the service provider 405 proceeds to S1703 again. In subsequent S1703, the setting item name as a new processing target is selected from the setting item names that are not selected yet, and the processing from S1704 to S1711 is repeated. In S1702, if it is determined that all the setting item names are selected as the processing target, the service provider 405 ends the processing of the loop 1 and proceeds to S1712.

S1704 to S1710 are loop processing (a loop 2). In S1705, the service provider 405 selects the value as the processing target from the settable values of the MFP 110 associated with the setting item name as the processing target of the loop 1 in the device capability information table 530. Then, the service provider 405 executes the processing from S1706 to S1709 for the settable value as the processing target, transitions to S1710, and returns to S1704. In S1704, if it is determined that there is the value that is not selected as the processing target yet from the settable values associated with the setting item name as the processing target of the loop 1, the service provider 405 proceeds to S1705 again. In subsequent S1705, the value as a new processing target is selected from the settable values that are not selected yet, and the processing from S1706 to S1709 is repeated. In S1704, if it is determined that all the settable values are selected as the processing target, the service provider 405 ends the processing of the loop 2 and proceeds to S1711.

In S1706, the service provider 405 determines whether the settable value as the processing target obtained in S1705 is included in the positive list in the setting list 1500 generated by the Web application 410. If it is determined that the settable value as the processing target is included in the positive list (YES in S1706), the service provider 405 proceeds to S1708.

For example, in a case where the setting list 1500 in FIG. 15A or 15B is obtained in S1701, “Color” is added to the colorMode tag 1524 associated with the positiveList tag 1522 indicating the positive list. Additionally, in a case where the settable value as the processing target is “Color,” the service provider 405 determines that “Color” that is the settable value as the processing target is included in the positive list.

In S1708, the service provider 405 adds a GUI button to the scan setting screen 820 to allow the user to select the settable value as the processing target obtained in S1705 as the scan setting.

For example, it is assumed that the setting item name as the processing target of the loop 1 is “colorMode” and the settable value as the processing target of the loop 2 is “Color.” In this case, the service provider 405 generates the scan setting screen 820 including a color selection GUI button 827 corresponding to “Color” in the color selection button display region 821 corresponding to the setting item name of “colorMode.” That is, the color selection GUI button 827 for the instruction to scan in color is set to be included in the scan setting screen 820.

On the other hand, if it is determined that the settable value as the processing target is not included in the positive list (NO in S1706), the service provider 405 proceeds to S1707.

In S1707, the service provider 405 determines whether the settable value as the processing target obtained in S1705 is included in the negative list in the setting list 1500 generated by the Web application 410. If it is determined that the settable value as the processing target is included in the negative list (YES in S1707), the service provider 405 proceeds to S1709, and if not (NO in S1707), the service provider 405 proceeds to S1708 described above.

In S1709, the service provider 405 sets the settable value as the processing target obtained in S1705 so as not to be selected by the user as the scan setting. Specifically, the scan setting screen 820 not including the GUI button that allows the user to select the settable value as the processing target is generated.

In S1712, the service provider 405 determines whether there are one or more GUI buttons corresponding to the settable value of the MFP 110 on the scan setting screen 820 generated as a result of the generation processing from S1702 to S1711. Alternatively, as the determination in S1712, the service provider 405 may determine whether the job setting screen in a state of accepting at least one settable value as the scan setting is generated. If it is determined that there is one or more GUI buttons corresponding to the settable value on the generated scan setting screen 820 (YES in S1712), the service provider 405 proceeds to S1714, and if not (NO in S1712), the service provider 405 proceeds to S1713.

In S1713, the service provider 405 notifies the Web application 410 of an error indicating that there is no settable value that can be selected by the user. Then, the processing in the flowchart in FIG. 17 ends.

S1714 is the processing in S729 in FIG. 7, and the service provider 405 of the MFP 110 displays the scan setting screen 820 generated as a result of the generation processing from S1702 to S1711 on the display unit on the operation unit 210 of the MFP 110.

For example, it is assumed that the setting list 1500 that is generated by the Web application 410 and transmitted to the MFP 110 is the setting list in FIG. 15A. In the setting list 1500 in FIG. 15A, no setting value is included in the negativeList tag 1525 indicating the negative list. Therefore, in the flowchart in FIG. 17 executed by the MFP 110, the processing does not transition to S1709 regardless of the value of the settable value as the processing target, and the processing transitions to S1708. Therefore, in S1714, the scan setting screen 820 that allows the user to select all the settable values included in the settable value list 1300 is displayed as illustrated in FIG. 10A.

Alternatively, in a case where the setting list 1500 that is generated by the Web application 410 and transmitted to the MFP 110 is the setting list in FIG. 15B or 15C, in S1701, the setting list 1500 in FIG. 15B or 15C is obtained. In the setting list 1500 in FIG. 15B or 15C, “GrayScale” is added to the colorMode tag 1527 associated with the negativeList tag 1525 indicating the negative list. Therefore, in a case where the settable value as the processing target in the loop 2 is “GrayScale,” in S1707, the service provider 405 determines that “GrayScale” as the processing target is included in the negative list. In S1709, the scan setting screen 820 not including a grayscale selection GUI button 828 corresponding to “GrayScale” is generated. As a result, in S1714, the scan setting screen 820 not including the grayscale selection GUI button 828 for the instruction to scan in grayscale is displayed in the color selection button display region 821 as illustrated in FIG. 10B. That is, the scan setting screen 820 that includes a GUI button corresponding to a value other than the setting value included in the negative list out of the setting values (the settable values) settable in the MFP 110 is displayed.

The service provider 405 displays a GUI button corresponding to a default value as a GUI button that is displayed on the top (at the leading) in the regions 821 to 824 to display the GUI button corresponding to each setting item name. For example, in the color selection button display region 821, since the default value of the setting item name “colorMode” is “color,” in FIGS. 10A and 10B, the color selection GUI button 827 corresponding to “color” is displayed on the top.

As described above, according to the present embodiment, even in a case of the job instructed by the Web application 410, the Web application 410 does not need to display the job setting screen, the preview screen, and the execution result screen via the Web browser. The MFP 110 can generate and display the job setting screen according to the setting list 1500 generated with the Web application 410 selecting the setting value from the settable value list 1300.

In order to generate the setting list 1500 by the Web application 410, the operator side of the Web application 410 only needs to generate in advance the list of the setting values that are not expected to be displayed in the MFP 110 as illustrated in FIG. 6C. Therefore, it is possible to reduce the cost of the operator side of the Web application 410 more than a case where the Web application 410 generates the job setting screen displayed on the Web browser of the MFP 110. Besides, it is possible to display the job setting screen, which allows the user to select the setting value that is expected by the operator of the service provided by the Web application 410 to be selected and allows the user not to select the setting value that is not expected to be selected, on the display unit of the MFP 110.

### Embodiment 2

In the embodiment 1, it is described that the service provider 405 included in the MFP 110 generates the job setting screen from which the GUI button corresponding to the setting value included in the negative list generated by the Web application 410 is deleted. For example, there may be a case where the user wants to refer to also the GUI button corresponding to the setting value included in the negative list. Therefore, in the present embodiment, processing in which the service provider 405 generates the job setting screen that displays also the GUI button corresponding to the setting value included in the negative list is described. The present embodiment is described focusing on a difference from the embodiment 1. A portion not particularly described is the same configuration and processing as that in the embodiment 1.

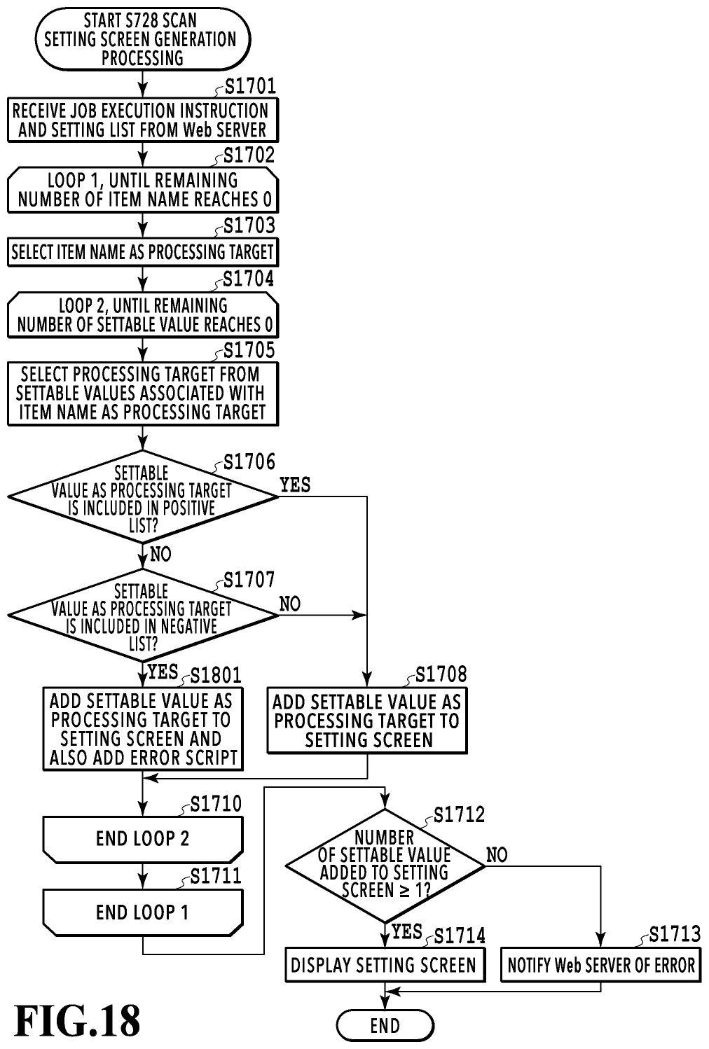

FIG. 18 is a flowchart describing the job setting screen generation processing of the present embodiment executed in S728 in FIG. 7. FIG. 18 is a flowchart corresponding to FIG. 17 in the embodiment 1. A step in FIG. 18 to perform the same processing as that in FIG. 17 is provided with the same step number as that in FIG. 17 also in FIG. 18. In the flowchart in FIG. 18, S1801 is executed instead of S1709 in the flowchart in FIG. 17. If it is determined that the settable value as the processing target of the loop 2 is included in the negative list generated by the Web application 410 (YES in S1708), in the present embodiment, the service provider 405 proceeds to S1801.

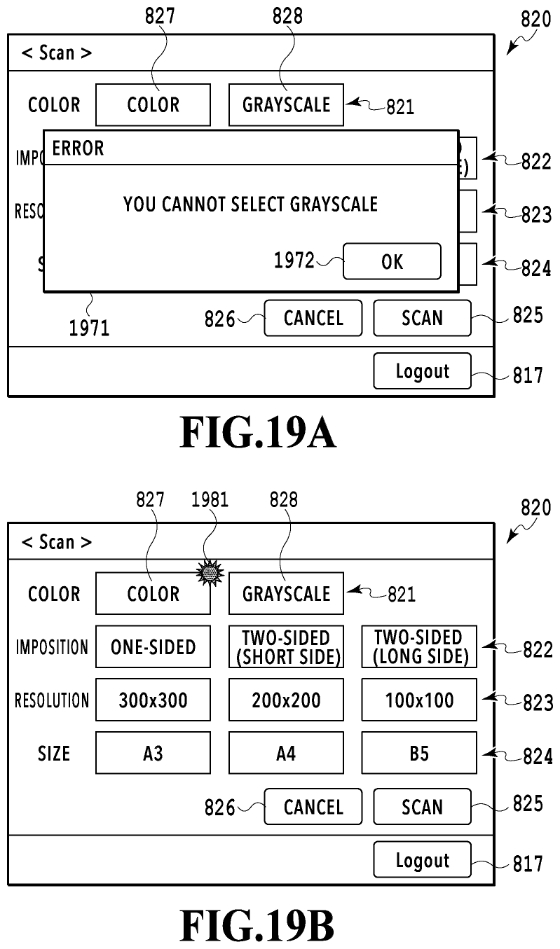

In S1801, the service provider 405 adds the GUI button corresponding to the settable value as the processing target obtained in S1705 to the scan setting screen 820. In addition, the service provider 405 adds an error script to display an error dialogue 1971 (see FIG. 19A) in a case where the added GUI button is pressed to the scan setting screen 820.

For example, it is assumed that the setting item name as the processing target of the loop 1 is “colorMode,” and the settable value as the processing target of the loop 2 is “GrayScale.” Additionally, it is assumed that “GrayScale” is included in the negative list generated by the Web application 410. In this case, in S1801, the service provider 405 generates the scan setting screen 820 including the grayscale selection GUI button 828 corresponding to “GrayScale.” That is, the service provider 405 generates a screen having the same appearance as that of the scan setting screen 820 in FIG. 10A.

FIG. 19A is a diagram illustrating an example of the error dialogue. It is assumed that the grayscale selection GUI button 828 corresponding to the settable value included in the negative list is pressed on the scan setting screen 820. The error script is added to the scan setting screen 820 so as to display the error dialogue 1971 in this case as illustrated in FIG. 19A.

Thus, in the present embodiment, even in a case where the value is included in the negative list in the setting list 1500 generated by the Web application 410, apparently, the scan setting screen 820 displaying the GUI buttons corresponding to all the settable values is displayed. Therefore, according to the present embodiment, it is possible to display the job setting screen that allows the user to refer to all the settable values of the MFP 110.

Additionally, in a case where the user presses the grayscale selection GUI button 828 corresponding to the settable value included in the negative list, the service provider 405 displays the error dialogue 1971 without accepting the setting of the settable value included in the negative list. In a case where the user presses an OK button 1972 of the error dialogue 1971, the error dialogue 1971 is closed, and the screen transitions to the previous state. Therefore, as with the embodiment 1, the Web application 410 can display the scan setting screen that does not allow the scan setting with the settable value included in the negative list generated by the Web application 410 on the MFP 110.

### Embodiment 3

In the above-described embodiment, it is described that the GUI button corresponding to the settable value included in the positive list generated by the Web application 410 displays another GUI button similarly on the job setting screen. For example, in some cases, the service provided by the Web application 410 wants to recommend the user to select the setting value included in the positive list. Therefore, in the present embodiment, a method of generating the job setting screen that recommends selection of the settable value included in the positive list is described. The present embodiment is described focusing on a difference from the embodiment 1. A portion not particularly described is the same configuration and processing as that in the embodiment 1.

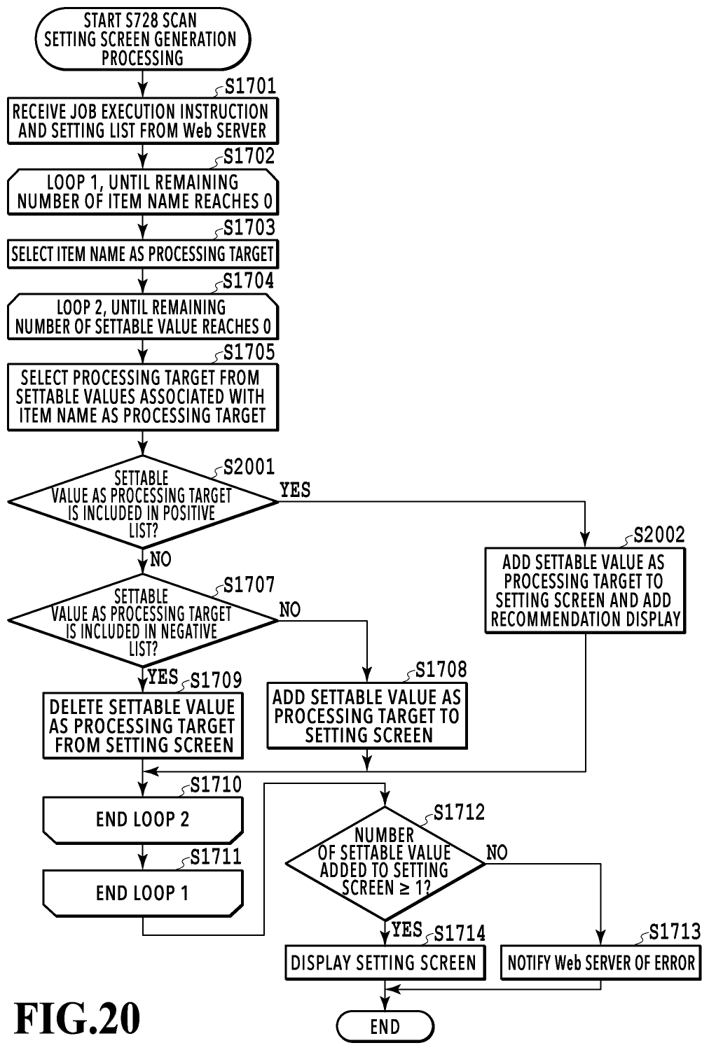

FIG. 20 is a flowchart describing the job setting screen generation processing in the present embodiment executed in S728 in FIG. 7. That is, FIG. 20 is a flowchart of the present embodiment corresponding to FIG. 17 in the embodiment 1. A step in FIG. 20 to perform the same processing as that in FIG. 17 is provided with the same step number as that in FIG. 17 also in FIG. 20.

In the flowchart in FIG. 20, S2001 is executed instead of S1706 in the flowchart in FIG. 17. In S2001, the service provider 405 determines whether the settable value as the processing target of the loop 2 is included in the positive list in the setting list 1500 generated by the Web application 410. If it is determined that the settable value as the processing target is included in the positive list (YES in S2001), the service provider 405 proceeds to S2002, and if not (NO in S2001), the service provider 405 proceeds to S1707.

In S2002, the service provider 405 adds the GUI button corresponding to the settable value as the processing target obtained in S1705 to the scan setting screen 820. In addition, the service provider 405 adds a recommendation display icon 1981 (see FIG. 19B) to recommend pressing to the added GUI button.

FIG. 19B is a diagram illustrating an example of the scan setting screen in a case where the recommendation display icon 1981 is added in S2002. For example, it is assumed that the setting item name as the processing target of the loop 1 is “colorMode,” and the settable value as the processing target of the loop 2 is “Color.” Additionally, it is assumed that the setting list 1500 in which “Color” as the processing target of the loop 2 is included in the positive list is received from the Web application. In this case, in S2002, the service provider 405 includes the color selection GUI button 827 corresponding to “Color” in the scan setting screen 820. In addition, in S2002, the service provider 405 adds the recommendation display icon 1981 to the color selection GUI button 827 as illustrated in FIG. 19B.

On the other hand, as with the embodiment 1, the service provider 405 adds the settable value of the MFP 110 not included in either positive list or negative list in the setting list 1500 to the scan setting screen 820 as a normal GUI button.

As described above, in the present embodiment, the scan setting screen 820 displays the recommendation on the GUI button corresponding to the settable value included in the positive list. Therefore, the user can confirm the recommended setting from the scan setting screen 820.

Note that, the method of displaying the recommendation in S2002 is not limited to the method of adding the recommendation display icon 1981 to the GUI button. In addition, for example, it is possible to notify the user of the recommended setting by coloring the GUI button with a different color from that of the other GUI button, blinking the GUI button, adding a message indicating that it is a recommendation display to the GUI button, and the like. Additionally, the method of the present embodiment may be applied to the embodiment 2.

### Other Embodiments

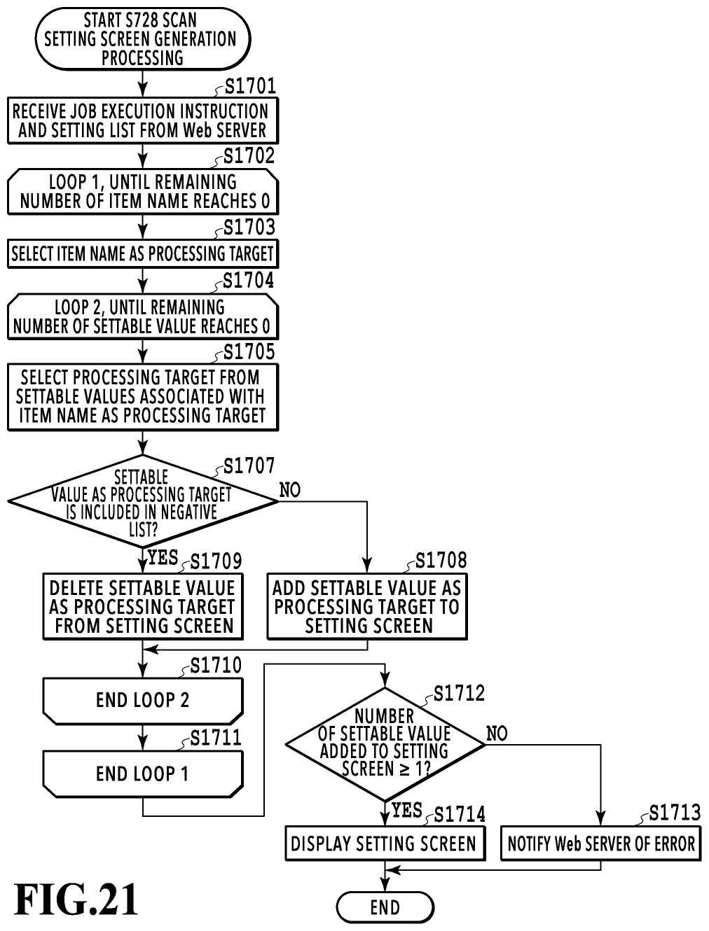

FIG. 21 is a diagram illustrating a modification of the job setting screen generation processing. The flowchart in FIG. 21 is a flowchart from which the step in S1706 to determine whether the settable value as the processing target of the loop 2 is included in the positive list in FIG. 17 is deleted. The service provider 405 of the MFP 110 may generate and display the scan setting screen 820 according to the flowchart in FIG. 21. Additionally, the Web application 410 may transmit the setting list 1500 as illustrated in FIG. 15C that includes the negative list but no positive list to the MFP 110.

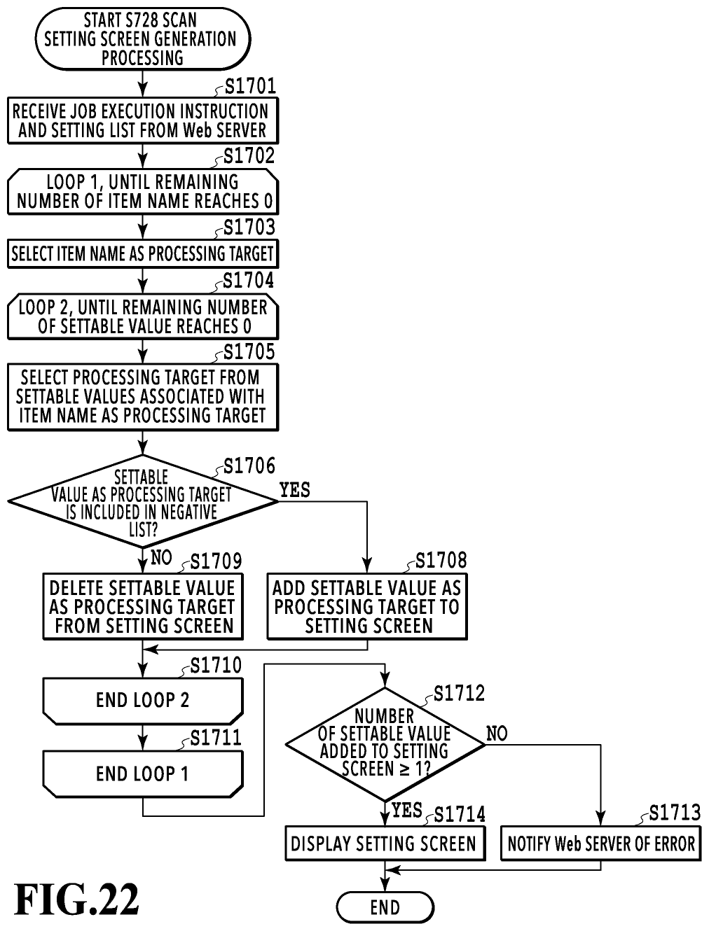

FIG. 22 is a diagram illustrating another modification of the job setting screen generation processing. The flowchart in FIG. 22 is a flowchart from which the step in S1707 to determine whether the settable value as the processing target of the loop 2 is included in the negative list in FIG. 17 is deleted. In FIG. 22, for example, the job setting screen is generated such that the GUI button corresponding to the settable value that is not included in the positive list is not included in the job setting screen. For example, it is assumed that the Web application 410 transmits the positive list including the settable value that can be selected by the user from the scan setting screen 820 to the MFP 110. In this case, the service provider 405 may generate and display the job setting screen according to the flowchart in FIG. 22. In a case where the MFP 110 performs the processing as illustrated in FIG. 22, the Web application 410 may transmit the setting list 1500 that includes the positive list but no negative list to the MFP 110.

Additionally, it is described that the GUI button displayed by the service provider 405 on the top in the regions 821 to 824 to display the GUI button on the scan setting screen 820 is the GUI button corresponding to the default value. The default value may be determined by the Web application 410. For example, a tag to set the default value is provided to the setting list 1500, and the Web application 410 generates the setting list 1500 by describing the settable value as the default value in the tag. The service provider 405 may obtain the settable value that is set as the default value from the setting list 1500 generated by the Web application 410 and generate the job setting screen that displays the GUI button to which the obtained settable value is set as the default value.

The present disclosure is achieved also with a computer of a system or an apparatus (or a CPU and an MPU) reading out and executing a program code from a storage medium storing the program code implementing the procedure of the flowchart described in the above-described embodiment. In this case, the program code itself read out from the storage medium implements the function of the above-described embodiment. Therefore, the program code and the storage medium storing the program code also form one of the techniques of the present disclosure.

As the storage medium to supply the program code, for example, it is possible to use a floppy (registered trademark) disc, a hard disk, an optical disc, a magnetooptical disc, a CD-ROM, a CD-R, a magnetic tape, a non-volatile memory card, a ROM, and so on.

Additionally, the execution of the program code read out by the computer causes not only the implementation of the function of the above-described embodiment. This also includes a case where an operating system (OS) and the like operating on the computer based on the instruction of the computer code performs a part of or the whole actual processing, and the function of the above-described embodiment is implemented by the processing.

Moreover, the following case is also included. The program code read out from the storage medium is written in a memory included in a functionality expansion board inserted in the computer and a functionality expansion unit connected to the computer. Then, based on the instruction of the program code, a CPU and the like included in the functionality expansion board and the functionality expansion unit perform a part of or the whole actual processing, and the function of the above-described embodiment is implemented by the processing.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-151330, filed Sep. 3, 2024, which is hereby incorporated by reference herein in its entirety.

What is claimed is:

1. An image processing apparatus, comprising:
a reception unit configured to receive, from an external server, an instruction to execute a job and a setting value selected in the external server from a plurality of setting values that can be set in the image processing apparatus;
a generation unit configured to generate a setting screen to accept setting of the job by a user, based on the received setting value; and
a display control unit configured to display the setting screen.

2. The image processing apparatus according to claim 1, wherein
the display control unit displays the setting screen in a state in which the user cannot select the received setting value.

3. The image processing apparatus according to claim 1, wherein
the display control unit displays the setting screen in a state in which the user cannot select a setting value other than the received setting value from the plurality of setting values.

4. The image processing apparatus according to claim 1, wherein
the reception unit at least receives a setting value included in a first list and a setting value included in a second list as the setting value selected in the external server.

5. The image processing apparatus according to claim 4, wherein
the display control unit displays the setting screen that includes a GUI to allow the user to select the setting value included in the first list but no GUI to allow the user to select setting value included in the second list.

6. The image processing apparatus according to claim 5, wherein
the display control unit displays the setting screen that further includes a GUI to allow the user to select a setting value that is not included in either of the first list and the second list from the plurality of setting values.

7. The image processing apparatus according to claim 4, wherein
the display control unit displays the setting screen in a state in which the user is accepted to select the setting value included in the first list and the user is not accepted to select the setting value included in the second list.

8. The image processing apparatus according to claim 7, wherein
the display control unit displays the setting screen that includes a GUI corresponding to each of the plurality of setting values and detects an error in a case where the user selects a GUI corresponding to the setting value included in the second list.

9. The image processing apparatus according to claim 4, wherein
the display control unit displays the setting screen that displays the setting value included in the first list in a recommendation state.

10. The image processing apparatus according to claim 1, wherein
the reception unit further receives, from the external server, a setting value that is a default value corresponding to a setting item name, and
the display control unit displays a GUI corresponding to a setting value that is the default value at the leading of GUIs corresponding to the setting item name on the setting screen.

11. The image processing apparatus according to claim 1, further comprising:
a notification unit configured to notify the external server of an error in a case where the setting screen generated based on the received setting value is a setting screen in a state in which none of the plurality of setting values is accepted.

12. The image processing apparatus according to claim 1, wherein
a screen displayed by the display control unit
transitions from a screen displayed on a Web browser by an application program in the external server to the setting screen and
transitions from the setting screen to the screen displayed on the Web browser by the application program in a case where execution of the job is completed.

13. The image processing apparatus according to claim 1, further comprising:
an execution unit configured to execute the job based on setting selected by the user via the setting screen.

14. The image processing apparatus according to claim 1, further comprising:
a scanner configured to scan an original document, wherein
the job is a job to transmit a scanned image obtained with the scanner scanning the original document to the external server.

15. A control method of an image processing apparatus, comprising:
receiving, from an external server, an instruction to execute a job and a setting value selected in the external server from a plurality of setting values that can be set in the image processing apparatus;
generating a setting screen to accept setting of the job by a user based on the received setting value; and
displaying the setting screen.

16. A non-transitory computer readable storage medium storing a program which causes a computer to perform a control method of an image processing apparatus, the control method comprising:
receiving, from an external server, an instruction to execute a job and a setting value selected in the external server from a plurality of setting values that can be set in the image processing apparatus;
generating a setting screen to accept setting of the job by a user based on the received setting value; and
displaying the setting screen.
